(19) United States
(12) Patent Application Publication
(10) Pub. No.: US 2015/0228005 A1
(43) Pub. Date: Aug. 13, 2015

(54) DISTRIBUTION MANAGEMENT FOR PURCHASE REQUISITIONS

(71) Applicant: Oracle International Corporation, Redwood Shores, CA (US)

(72) Inventors: Shibhu Nambiar, Springfield, VA (US); Suman Guha, Fremont, CA (US); Lee Quek, Foster City, CA (US); Xiang Xian, Cupertino, CA (US); Mayukh Bhaowal, Redwood City, CA (US)

(73) Assignee: Oracle International Corporation, Redwood Shores, CA (US)

(21) Appl. No.: 14/177,061

(22) Filed: Feb. 10, 2014

(51) Int. Cl. G06Q 30/06

(52) U.S. Cl. CPC G06Q 30/0635

(57) ABSTRACT

Embodiments of the present invention are directed to techniques (e.g., systems and methods) for management and tracking of distribution and schedules of a purchase order associated with a purchase requisition. In certain embodiments, a procurement management system can manage information and relationships between split or new distribution and/or schedule requirements for a purchase order in fulfillment of a purchase requisition. In particular, information about a purchase requisition, such as a requisition identifier (requisition ID), can be stored and used later to manage and track distribution and/or schedules for fulfillment of one or more purchase orders. Using information stored about a relationship between a purchase requisition and the distributions and the schedules for a purchase order, a procurement management system can ascertain details about distribution and schedules of a purchase order for fulfillment of a purchase requisition.

### TECHNICAL FIELD

Embodiments of the present invention relate generally to managing procurement information. More specifically, the embodiments related to managing information about purchase requisitions.

### BACKGROUND

An organization can manage and track its procurement of goods and/or services via formal request procedure referred to as a purchase requisition. A purchase requisition identifies information about one or more requested goods/services for procurement by a buyer (e.g., an organization or an entity). A purchase requisition can include one or more lines (or entries), each including a description of an item (e.g., a good or a service), a quantity of the item, a preferred make of the item, a desired delivery date, a cost center in the organization, an amount of money authorized for the item, and/or other information about the item. Once a purchase requisition is approved by the organization, the organization can locate a supplier for delivery of the item(s) identified in a purchase requisition. The organization and the supplier can enter an agreement defined by a purchase order, which can detail information related to delivery of the item(s) in a purchase requisition.

A purchase order can include one or more lines (or entries), each include an item and a price of the item. The purchase order can include a schedule and distribution information. The schedule information can include shipment information such as one or more ship-to locations and a delivery date. A ship-to location can indicate a shipping dock, a mail room, or other location for shipment. The distribution information can include billing information such as cost center to be charged. The billing information can include information about a project to be charged. The distribution information includes one or more deliver-to locations, each of which indicates a location (e.g., a cube, an office, a building, etc.) of the requester asking for the goods.

Sometimes, a schedule for a purchase order may be split to deliver goods to different locations or to deliver goods on different dates. A distribution for a purchase order can be split sometimes because there is a need to charge a purchase order to a different cost center or project. A distribution can be split because delivery of goods identified in the purchase order need to be delivered to different requesters. As a result of splitting distribution or a schedule or a purchase order, a reference to a backing requisition (e.g., a purchase requisition corresponding to the purchase order), can be lost. As a result, tracking fulfillment of a purchase order can be challenging since a reference to a backing requisition is lost. Based on the type of split details about individual a purchase order may be severed from the backing purchase requisition.

### BRIEF SUMMARY

Embodiments of the present invention are directed to techniques (e.g., systems and methods) for management and tracking of distribution and schedules of a purchase order associated with a purchase requisition. In certain embodiments, a procurement management system can manage information and relationships between split or new distribution and/or schedule requirements for a purchase order in fulfillment of a purchase requisition. In particular, information about a purchase requisition, such as a requisition identifier (requisition ID), can be stored and used later to manage and track distribution and/or schedules for fulfillment of one or more purchase orders. Using information stored about a relationship between a purchase requisition and the distributions and the schedules for a purchase order, a procurement management system can ascertain details about distribution and schedules of a purchase order for fulfillment of a purchase requisition.

In certain embodiments, a procurement management system can generate records to store and manage information about purchase requisitions and related purchase orders. A unique requisition ID can be stored in association with a purchase requisition line in a purchase requisition. The procurement management system can store an original requisition ID for a purchase requisition in association with information for each distribution and/or each schedule that fulfills a part of a purchase order for the purchase requisition. In the event that a distribution is split (or separated), or alternatively, a new distribution is added to a purchase order, the procurement management system can store the requisition ID with information associated with the new or different distribution. In the event that a schedule for a purchase order is split (or separated), or alternatively, a new schedule is added to a purchase order, the procurement management system can store the requisition ID with information associated with the new or different schedule. In this manner, the procurement management system can provide information to a user about a status or details regarding distribution and/or schedules of a purchase order associated with a purchase requisition. The management of information about the relationship between a purchase requisition and distribution and/or schedules of a purchase orders can enable a user to accurately map a requisition lifecycle for receipts, deliveries, and invoices created originally for requested items.

In some embodiments, the procurement management system can generate one or more displayable graphical user interfaces (GUIs) that enable a user to manage purchase requisitions and track purchase orders for a purchase requisition. The displayable GUIs can enable receipt information associated with one or more purchase requisitions. The information can include details about one or more purchase orders for each of the purchase requisitions. In some embodiments, GUIs can be generated to enable a user to split or separate distribution and/or a schedule of a good for a purchase order and to provide details about each distribution for the purchase order. Using the information about the relationship between distributions and schedules for a given purchase order, procurement management system can generate GUIs that present details of each shipment, delivery, and/or billing schedule of a distribution for a purchase order. Such details about a purchase order can enable a user to effectively manage and track fulfillment of purchase requisitions based on distribution for purchase orders. For example, the procurement management system can enable a user to identify all distributions and/or schedules for any given purchase requisition. Specifically, the user can determine an amount of goods have been delivered for a purchase requisitions and an amount of goods that are remaining to be filled for the purchase requisitions. Of the goods that are remaining to be filled, the GUI can further enable the user to determine a status (e.g., shipment date or delivery date) or distribution information regarding the remaining goods are expected to be filled.

In certain embodiments, techniques (e.g., a method, a system, or a computer-readable memory storing instructions executable to perform a method) are provided for managing distribution and/or schedules of one or more purchase orders for a purchase requisition. The technique can include determining distribution information or a schedule of a purchase order. The technique further includes receiving a request to separate a portion of the distribution or the schedule for the purchase order into plurality of different distributions or a plurality of different schedules, respectively. The technique further includes receiving a request to separate a portion of the schedule for a purchase order into plurality of different schedules. The technique includes determining an original requisition identifier of a purchase requisition associated with the purchase order. Further, the technique includes storing the plurality of different distributions and/or a plurality of different schedules in association with the original requisition identifier. Based on an original requisition identifier associated with a purchase requisition, distribution and/or schedules related to a purchase order for the purchase requisition can be located. The distribution information can be presented in a GUI to enable a user to manage and track distribution and/or schedules of a purchase order for fulfillment of a purchase requisition.

The following detailed description together with the accompanying drawings will provide a better understanding of the nature and advantages of the present invention.

### BRIEF DESCRIPTION OF THE DRAWINGS

FIG. 1 is a block diagram of a system according to some embodiments of the present invention.

FIG. 2 shows a graphical user interface according to some embodiments of the present invention.

FIG. 3 shows a graphical user interface according to some embodiments of the present invention.

FIG. 4 shows a graphical user interface according to some embodiments of the present invention.

FIG. 5 shows a graphical user interface according to some embodiments of the present invention.

FIG. 6 shows a graphical user interface according to some embodiments of the present invention.

FIG. 7 shows a graphical user interface according to some embodiments of the present invention.

FIG. 8 shows a graphical user interface according to some embodiments of the present invention.

FIG. 9 shows a graphical user interface according to some embodiments of the present invention.

FIGS. 10A-10C show data structures according to some embodiments of the present invention.

FIGS. 11A-11D show data structures according to some embodiments of the present invention.

FIGS. 12A and 12B show data structures according to some embodiments of the present invention.

FIGS. 13A and 13B each show a flowchart of a process according to some embodiments of the present invention.

FIG. 14 depicts a simplified diagram of a distributed system for implementing one of the embodiments.

FIG. 15 is a simplified block diagram of components of a system environment by which services provided by the components of an embodiment system may be offered as cloud services, in accordance with an embodiment of the present disclosure.

FIG. 16 illustrates an exemplary computer system, in which various embodiments of the present invention may be implemented.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

Embodiments of the present invention are directed to techniques (e.g., systems and methods) for management and tracking of distribution and schedules of a purchase order associated with a purchase requisition. In certain embodiments, a procurement management system can manage information and relationships between split or new distribution and/or schedule requirements for a purchase order in fulfillment of a purchase requisition. In particular, information about a purchase requisition, such as a requisition identifier (requisition ID), can be stored and used later to manage and track distribution and/or schedules for fulfillment of one or more purchase orders. Using information stored about a relationship between a purchase requisition and the distributions and the schedules for a purchase order, a procurement management system can ascertain details about distribution and schedules of a purchase order for fulfillment of a purchase requisition.

In certain embodiments, a procurement management system can generate records to store and manage information about purchase requisitions and related purchase orders. A unique requisition ID can be stored in association with a purchase requisition line in a purchase requisition. The procurement management system can store an original requisition ID for a purchase requisition in association with information for each distribution and/or each schedule that fulfills a part of a purchase order for the purchase requisition. In the event that a distribution is split (or separated), or alternatively, a new distribution is added to a purchase order, the procurement management system can store the requisition ID with information associated with the new or different distribution. In the event that a schedule for a purchase order is split (or separated), or alternatively, a new schedule is added to a purchase order, the procurement management system can store the requisition ID with information associated with the new or different schedule. In this manner, the procurement management system can provide information to a user about a status or details regarding distribution and/or schedules of a purchase order associated with a purchase requisition. The management of information about the relationship between a purchase requisition and distribution and/or schedules of a purchase orders can enable a user to accurately map a requisition lifecycle for receipts, deliveries, and invoices created originally for requested items.

In some embodiments, the procurement management system can generate one or more displayable graphical user interfaces (GUIs) that enable a user to manage purchase requisitions and track purchase orders for a purchase requisition. The displayable GUIs can enable receipt information associated with one or more purchase requisitions. The information can include details about one or more purchase orders for each of the purchase requisitions. In some embodiments, GUIs can be generated to enable a user to split or separate distribution and/or a schedule of a good for a purchase order and to provide details about each distribution for the purchase order. Using the information about the relationship between distributions and schedules for a given purchase order, procurement management system can generate GUIs that present details of each shipment, delivery, and/or billing schedule of a distribution for a purchase order. Such details about a purchase order can enable a user to effectively manage and track fulfillment of purchase requisitions based on distribution for purchase orders. For example, the procurement management system can enable a user to identify all distributions and/or schedules for any given purchase requisition. Specifically, the user can determine an amount of goods have been delivered for a purchase requisitions and an amount of goods that are remaining to be filled for the purchase requisitions. Of the goods that are remaining to be filled, the GUI can further enable the user to determine schedules or distribution regarding the remaining goods are expected to be filled.

Prior to discussing the specific embodiments of the invention, a further description of some terms can be provided for a better understanding of embodiments of the invention.

As referred to herein, a “purchase requisition” or a “requisition” can be a request by an organization/entity for procurement of one or more items, such as a good or a service. A purchase requisition can include information descriptive a good/service requested for procurement. The information can be organized in a format such as one or more lines (e.g., an entry or a record), each of which includes information descriptive of a good/service that is requested for requisition. The information descriptive of a good/service can include a description of a good/service, a quantity of the good/service, a preferred make of the good/service, a desired delivery date for delivery of the good/service, a cost center in the organization for the good/service, an amount of money authorized by the organization for the good/service, and/or other information about the good/service.

A “purchase order” or “order” (e.g., PO) can be referred to as information about an agreement that describes information about one or more items (e.g., a good or a services) that a seller provides to a buyer to satisfy a purchase requisition. A purchase requisition can have a one-to-many relationship with purchase orders, such that a plurality of purchase orders can satisfy a purchase requisition. The information can be organized in a format such as one or more lines (e.g., an entry or a record), each of which includes information descriptive of a good/service that will be provided in satisfaction or fulfillment of a purchase requisition. The details in the purchase order can indicate an entity (e.g., an organization) or a group (e.g. a unit or a department) that receives a good or a service based on the purchase order. A purchase order can indicate a type of a good/service that a seller will provide to a buyer, a quantity of the good/service, an agreed price for the good/service, a destination to ship the good/service, a date when the good/service will be provided, other information about the good/service that will be provided, or a combination thereof.

A purchase order can have a one-to-many relationship with distributions and schedules. A distribution can include a plurality of distributions, each associated with distribution for a portion of a quantity of a good in a purchase order. A purchase order can have a plurality of schedules for distribution of all or a portion of a good in a purchase order.

A “schedule” can refer to a schedule (e.g., a shipment) for distribution of a purchase order. The schedule can include a ship-to location or destination (a shipping dock, a mail room, etc.), a delivery date (e.g., a need-by date), a delivery date (e.g., a need-by date).

A “distribution” can refer to distribution of a purchase order. A distribution can include information including a quantity of a good being shipped, a quantity received, or billing information. The billing information can indicate a quantity billed, a charge account, a party being charged, a project to be charged, and a deliver-to location.

Various additional details of embodiments of the present invention will be described below with reference to the figures. In the drawings, like numerals can represent like elements throughout the several figures, aspects of an exemplary operating environment, and the implementations described herein.

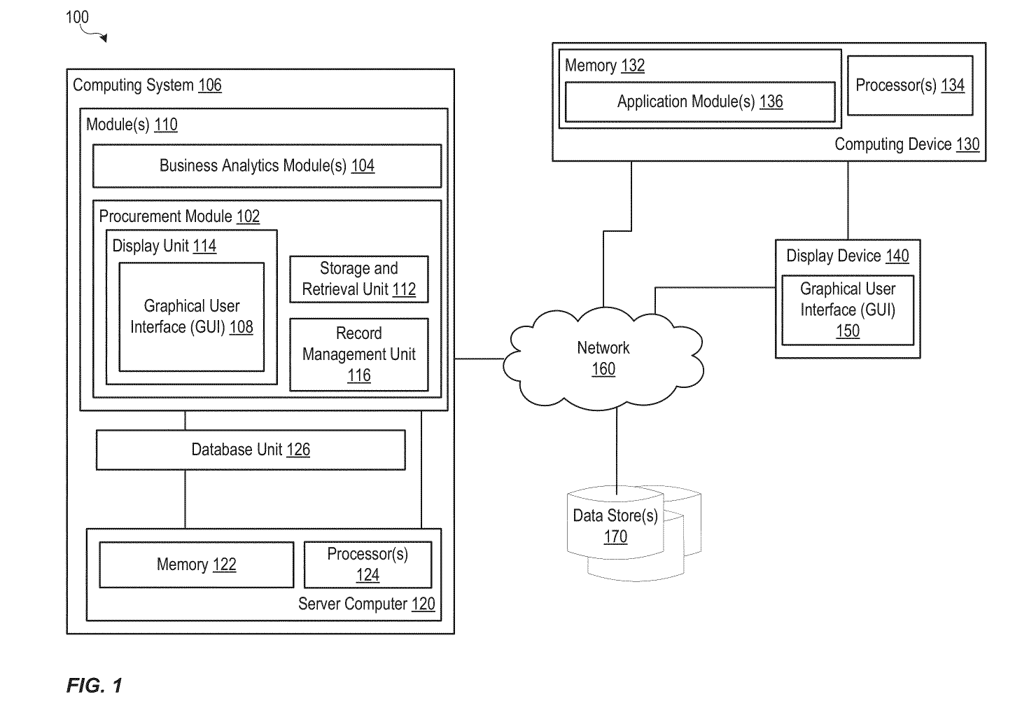

FIG. 1 is a block diagram of a system 100 according to some embodiments of the present invention. Specifically, system 100 illustrates high-level, functional components of a procurement management system for managing and tracking distribution of purchase order(s) associated with a purchase requisition.

System 100 can include elements such as computing system 106, computing device 130, display device 140, and one or more databases 170. The elements of system 100 can communicate with each other via network 160. The network 160 can be, for example, the Internet, a mobile network, a wireless network, a cellular network, a local area network (LAN), a wide area network (WAN), other communication networks, or a combination thereof.

The computing system 106 can include a combination of computer hardware and software to manage information/data for an organization. For example, the computing system 106 can include one or more server computers, such as server computer 120 (e.g., a web server computer). The computing system 106 can be configured to support a service oriented architecture (SOA) operated by one or more computing devices, e.g., server computer 120. In some embodiments, the computing system 106 can be a middleware computing system that facilitates communication and management of data in a distributed fashion through distributed applications and services. The services or applications can manage information and functionality for areas of management including financial management, human capital management, customer relationship management, supply chain management, procurement, governance, and/or project management.

The computing system 106 can include one or more modules 110 that include a combination of computer hardware and software. The one or more modules 110 can cause the computing system 106, when executed by the computed system, to perform one or more operations or methods to provide services or applications. The services or applications can be accessed via the computing system 106 or can be provided to a plurality of computing devices (e.g., the computing device 130) in a distributed manner.

The server computer 120 can include one or more memory devices, e.g., memory storage device 122, and one or more processors, e.g., processor 124. The memory storage device 122 can be accessible to the processor 124 and can include instructions stored thereon which, when executed by the processor 124, cause the processor 124 to perform one or more operations disclosed herein. The server computer 120 can execute instructions and/or one or more of the modules 110 to implement operations for the computing system 106.

The computing system 106 can include a database unit 126 that includes a combination of computer hardware and software to enable communication with one or more data stores, such as data store 170. The data store 170 can be implemented using any type of persistent storage device, such as a memory storage device. In some embodiments, the data store 170 can be implemented using a document database, a relational database, or other type of database. The database unit 126 can be included or implemented within the server computer 120. The computing system 106 can use the data store 170 to store and retrieve information associated with applications and/or services provided by the one or more modules 110. In certain embodiments, the data store 170 can store information related to procurement. The information related to procurement can be received from one or more other computing devices (e.g., the computing device 130) and/or data stores.

In certain embodiments, one or more display devices, e.g., the display device 140, can communicate with the computing system 106 to enable a user to operate the computing system 106. The display device can present one or more graphical user interfaces (GUIs), such as the GUI 150. The GUI 150 can be generated by the computing system 106. The GUI 150 can present one or more interactive elements. An interactive element as described herein can include a control, a button, or other GUI element that can be interacted with to cause input to be received. Interactions with the GUI 150 may be received as input data at the display device 140 and may be communicated to the computing system 106 and/or the computing device 130.

Note that a GUI depicted in the figures may represent a web-page that is presented to a user, with the graphical user interface including one or more interactive elements (such as radio buttons, drop-down menus, interactive elements, selectable controls, data entry fields) that may be selected and/or activated by a user. The display of the graphical user interface may result from any suitable method, including the execution of code or instructions, interpretation of markup language, etc. by a processing element (such as a browser or other application, computer, microprocessor, central processing unit, etc.). Further, the response to (or processing of) the selection or activation of a graphical user interface element may be the result of the execution of code or instructions, interpretation of markup language, etc. by a processing element (such as a browser or other application, computer, microprocessor, central processing unit, etc.). Thus, in some embodiments a method, process, function, or operation may be implemented as a result of the execution of code or a set of instructions by a suitably programmed processor or computing device.

Note that each of the figures depicting the GUI and associated elements may be associated with a software-implemented process or method that is implemented by a suitably programmed processor or computing device in order to: (a) generate one or more of the depicted graphical user interface elements; (b) permit a user to interact with one or more of the graphical user interface elements (such as by activating an element or entering data into a data field); (c) process a user's selection or activation of a graphical user interface element, or entry of data into a data field; or (d) perform one or more processes, operations or functions associated with the inventive service.

In certain embodiments, the modules 110 can include a business analytics module 104 and a procurement module 102. The business module 104, when operated or executed by the computing system 106, can cause the computing system to implement operations for providing, receiving, and/or managing business analytical information about an organization, such as metrics and/or statistics about an organization's procurement. For example, the business analytics module can provide services and/or applications to perform functions including business intelligence. The business analytics module 104 can communicate with the procurement module 102 to access information related to procurement.

In certain embodiments, the procurement module 102 that, when executed or operated by the computing system 106, can cause the computing system to implement operations for providing applications and/or services for procurement. The procurement module 102 can be implemented by one or more units including a combination of hardware/software. The one or more units can include a storage and retrieval unit 112, a display unit 114, and a record management unit 116.

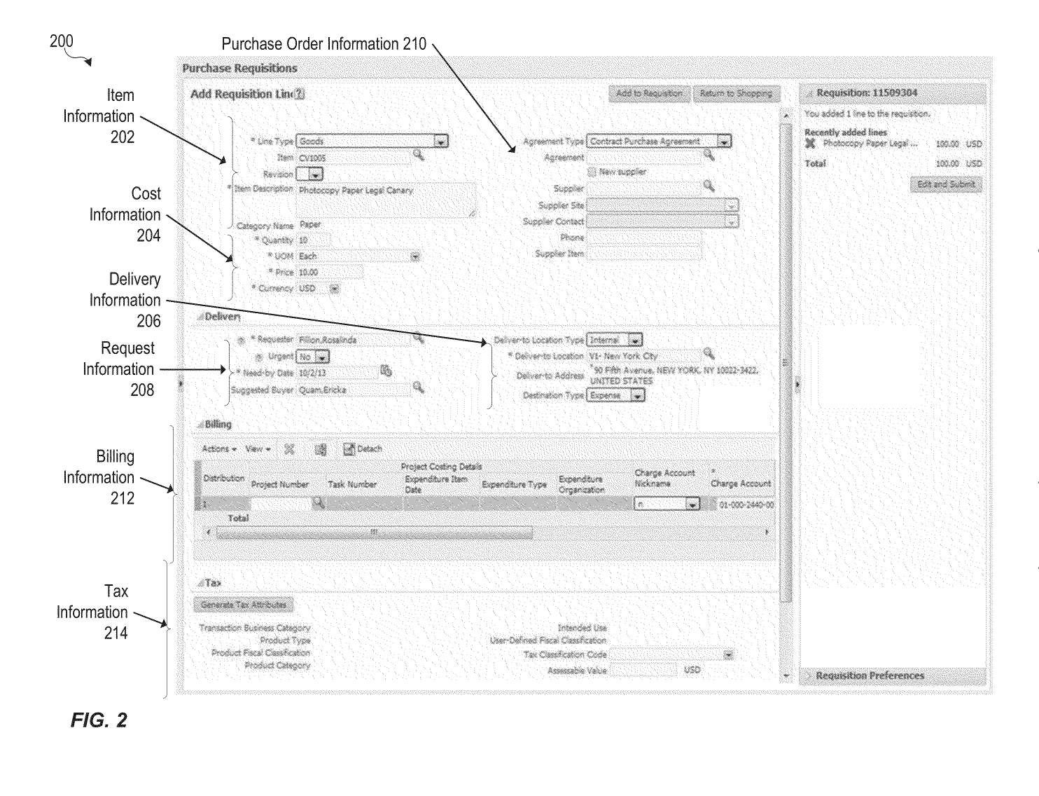

The display unit 114 can generate one or more GUIs, e.g., GUI 108, to enable a user to operate the computing system 106. The GUI 108 generated by the display unit 114 can be displayed at the display device 140. The GUI 108 can enable a user to access and operate the computing system 106. The GUI 108 can enable a user to manage (e.g., input, receive, edit, delete, etc.) information related to procurement, such as one or more purchase requisitions, one or more purchase orders, a life cycle of a purchase order, life cycle of a purchase requisition. The GUI 108 can enable a user to edit, create, delete, and/or update information related to purchase requisitions and/or purchase orders. For example, the GUI 108 can enable a user to split or separate distribution for a purchase order into a plurality of different distributions. In another example, the GUI 108 can enable a user to split or separate schedules for a purchase order into a plurality of different schedules. In certain embodiments, a relationship of purchase orders to a purchase requisition can be shown in the GUI 108. For example, each purchase order fulfilling a good/service of a purchase requisition can be displayed. Each distribution and/or schedule for a purchase order associated with the purchase requisition can be shown. In certain embodiments, the GUI 108 can be updated to show each different distributions of a plurality of different distributions split from distribution for a purchase order. In certain embodiments, the GUI 108 can be updated to show each different schedules of a plurality of different schedules split from a schedule for a purchase order. In certain embodiments, the GUI 108 can enable a user to search for information related to procurement. For example, the GUI 108 can provide functions to enable a search for purchase requisitions, information associated with purchase requisitions, purchase orders, schedules for purchase orders, distributions for purchase orders or a combination thereof. The search can enable identification of distributions and/or schedules for distribution of a purchase order associated with a purchase requisition. Examples of the GUIs (e.g., the GUI 108) can be further described with reference to FIGS. 2-9.

The storage and retrieval unit 112 can store and retrieve information related to procurement (e.g., purchase requisitions, purchase orders, etc.) from the data store 170. The information received via the GUI 108 can be stored in the data store 170 for retrieval at a later time. Information can be stored in one or more data structures, such as a record (e.g., a database record), that can be generated and managed by the record management unit 116 described below. The storage and retrieval unit 112 can obtain information related to procurement from the one or more other computing devices and/or computing systems via the data store 170.

To facilitate and support search functions via the GUI 108, the storage and retrieval unit 112 can search the data store 170 for information (e.g., records) associated with search criteria provided via the GUI 108. For example, the storage and retrieval unit 112 can search the data store 170 to locate information related purchase requisitions associated with a requisition ID. The requisition ID (e.g., an original requisition ID) can be a value that distinctly identifies information related to a distinct purchase requisition. The storage and retrieval unit 112 can search the data store 170 to identify information related to purchase orders (e.g., distributions and/or schedules for a purchase order) based on the requisition ID.

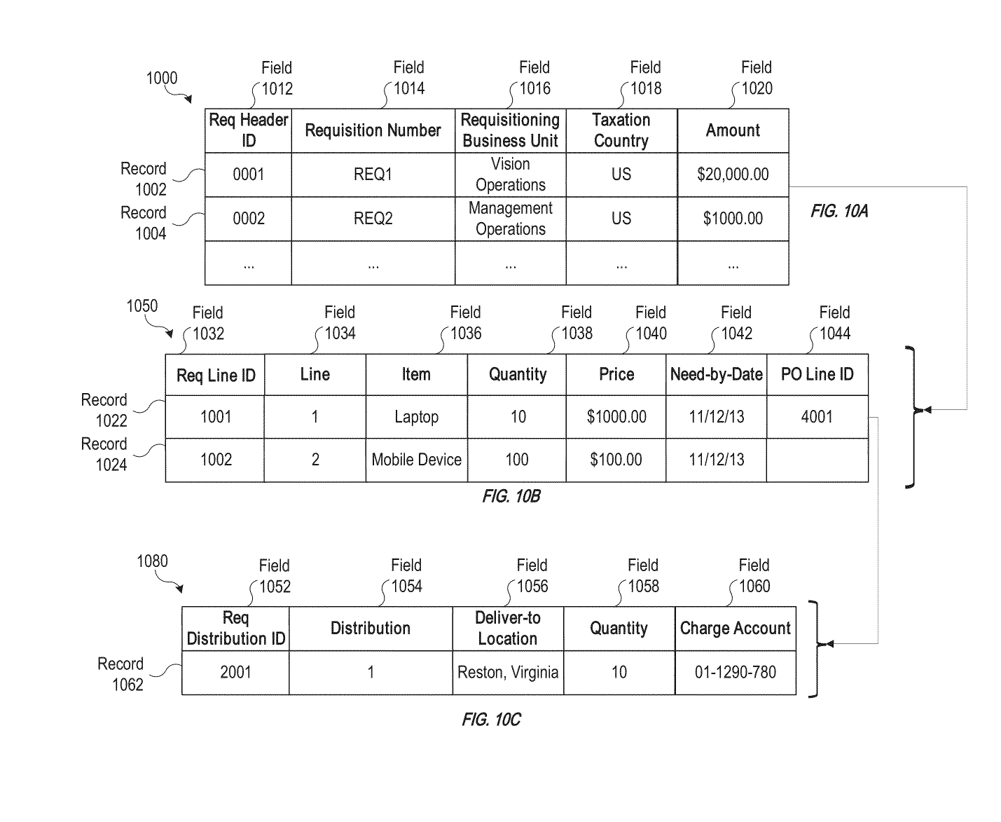

The record management unit 116 can generate one or more data structures, such as a record (e.g., a database record) for storage of information related to procurement. For example, the record management unit 116 can generate one or more records for a purchase requisition. The records can contain information such as a requisition header (e.g., information about a purchase requisition) and a requisition line corresponding to each unique requisition of a good/service that is being requested. A requisition ID can be generated for each of the one or more records that are generated for a purchase requisition. For example, the requisition ID can be generated for each distinct requisition line (or entry) in a purchase requisition. Alternatively or additionally, the requisition ID can be associated with each distribution for a requisition line in a purchase requisition. Each record generated by the record management unit 116 can be stored in the data store 170 by storage and retrieval unit 112. Examples of data structures generated and managed by the record management unit 116 can be further described with reference to FIGS. 10A-10C, 11A-11C, 12A, and 12B

The record management unit 116 can generate one or more records for a purchase order. The records can contain information such as a purchase order header that includes information about a purchase order. The records can also contain information about a purchase order line corresponding to each unique purchase order in a purchase order. Each unique purchase order line can be different based on one or both of a good/service being fulfilled. A distinct record can be generated for each purchase order line. A distinct record can be generated for each distinct distribution associated with a purchase order line. A distinct record can be generated for each distinct schedule associated with a purchase order line. The record management unit 116 can request the storage and retrieval unit 112 to store the requisition ID associated with a purchase requisition in associated with each record generated for the purchase order. Alternatively or additionally, the record management unit 116 can request the storage and retrieval unit 112 to store the requisition ID for each distinct distribution for a purchase order and each distinct schedule for a purchase order in association with for a purchase requisition. The requisition ID can enable the storage and retrieval unit 112 to identify records for a purchase order that are associated with a purchase requisition.

In certain embodiments, in the event that a new record is generated for a purchase order, the record management unit 116 can request the storage and retrieval unit 112 to store a requisition ID (e.g., an original ID) associated with existing records for the purchase order in association with the new record. For example, when a new record is generated for a new or different distribution and/or schedule, the new record can be stored in association with an original requisition ID associated with existing records for a purchase order. In this manner, the procurement module 102 can identify new distributions and/or schedules associated with a purchase requisition.

In the system 100, the computing device 130 can be located externally to the computing system 106, such as at a physical location different from a location of the computing system 106. The computing device 130 is not limited to embodiments described herein and can take any form for use by a user. For example, the computing device 130 can be a personal digital assistant (PDA), a tablet computer, a laptop computer, a desktop computer, a wearable computer, a pager, etc. The computing device 130 can include one or more memory devices, e.g., memory storage device 132, and one or more processors, such as processor 134. The memory storage device 132 can be accessible to the processor 134 and can include instructions stored thereon which, when executed by the processor 134, cause the processor 134 to perform one or more operations disclosed herein.

The computing device 130 can provide applications and/or services that enable a user to manage and receive information related to procurement. In certain embodiments, the computing device 130 can be operated to manage operation of the computing system 106. The computing device 130 can be operated through interaction with the display device 140. In particular, the GUI 150 can be used to view and manage operation of the computing device 130. In certain embodiments, the display device 140 can present GUIs (e.g., the GUI 108) generated in the computing system 106. Via the display device 140 or the GUI 150, a user can operate the computing system 106.

In certain embodiments, the memory storage device 132 can include one or more application modules, such as application module 136, which can include instructions that are executable by the processor 134 to perform operations described as being performed by the computing device 130. The application module 136 can include a combination of hardware/software for implementation of operations at the computing device 130. The application module 136 can provide applications and/or facilitate services that perform functions described above as being implemented by the computing system 106. The application module 136 can enable communication with the computing system 106 to operate one or more of the modules 110. Alternatively or additionally, the computing device 130 can receive one or more of the modules 110 to operate the computing system 106 from the computing device 130. In certain embodiments, the operations implemented at the computing system 106 can be implemented at the computing device 130. In some embodiments, all or a portion of the units in the procurement module 102 or operations performed by the procurement module 102 can be implemented at the computing device 130, such as by the application module 136. For example, the display unit 114 can be implemented at the computing device to generate GIs, such as the GUI 108 for display via the display device 140.

In operation, a user (e.g., a procurement administrator) can operate the computing system 106 and/or the computing device 130 to manage procurement information. One or more of the modules 110 (e.g., the procurement module 102) can implement operations for managing procurement information. The computing system 106 and/or the computing device 130 can operate the procurement module 102 to present one or more GUIs, such as the GUI 108 or the GUI 150 to enable the user to access and provide procurement information managed. The GUIs presented by the system 100 can include any of the GUIs described herein with reference to FIGS. 1-9. In some embodiments, the computing device 130 can operate the application module 136 to present an application program that can provide one or more GUIs (e.g., the GUI 108 or the GUI 150) for managing procurement information. For purposes of illustration, examples will be described with reference to the GUI 108.

The computing system 106 can receive procurement information from a user via one or more GUIs described herein. A user can interact with the GUI 108 to provide details to the computing system 106 about a purchase requisition for an organization. The procurement module 102 can receive the input provided in the GUI 108. The GUI 108 can present the GUI shown in FIG. 2 for creating a new purchase requisition. The GUI 108 can enable the user to specify a plurality of purchase requisition lines, each for a distinct item (e.g., a good or a service) to be requested by the purchase requisition. Once a purchase requisition has been established, the computing system 106 can also obtain procurement information from the data store 170 by operating the procurement module 102 to access the data store 170. In some embodiments, procurement information in the data store 170 may have been created by a user during a previous session in the system 100 or may have be received from another system during a previous time period.

In response to receiving procurement information for a new purchase requisition, the record management unit 116 can generate one or more new records to store the purchase requisition. Details about storage of a purchase requisition can be described further with reference to FIGS. 10A-10C. As a part of storing purchase requisition information, the procurement module 102 can generate a requisition ID that uniquely distinguishes a purchase requisition from other purchase requisitions. The procurement module 102 can use the requisition ID to associate any records or information related to a purchase order that exists for satisfaction the purchase requisition.

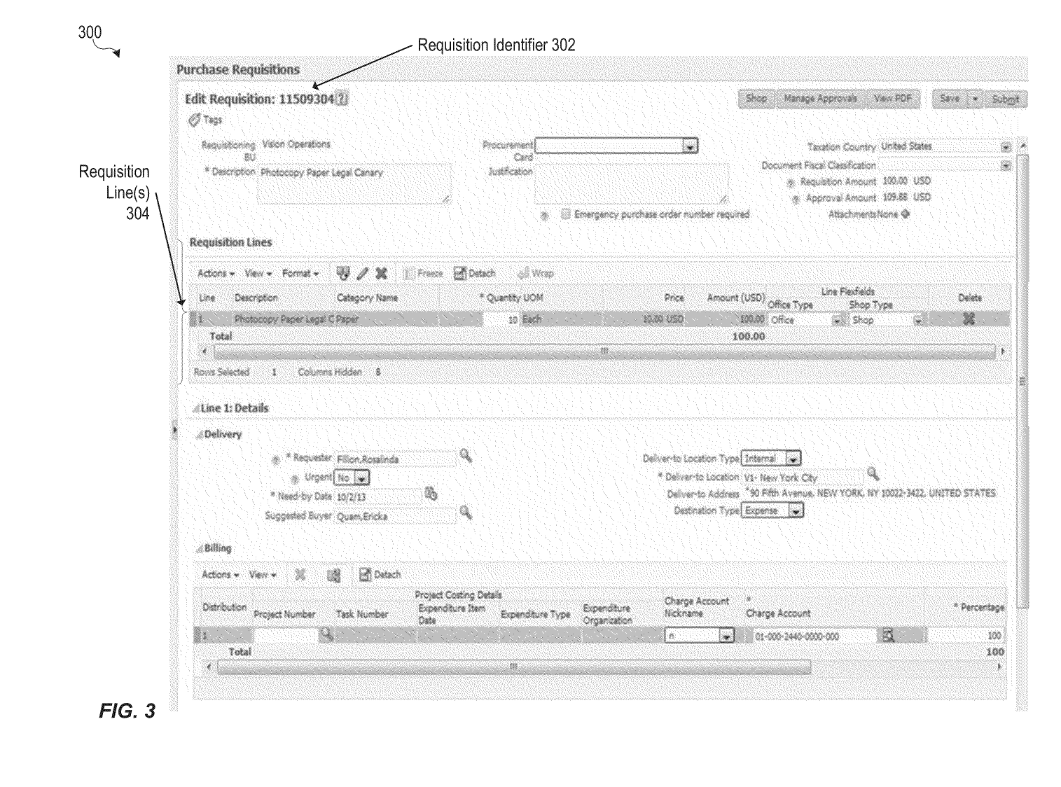

A user can interact with the GUI 108 to identify a purchase requisition to be updated or modified. The GUI 108 can include the GUI shown in FIG. 3, which enables a user to specify criteria for modifying a purchase requisition or for adding an additional purchase requisition entry to an existing purchase requisition. The procurement module 102 can use the requisition ID of an existing purchase requisition to store additional information received for a purchase requisition.

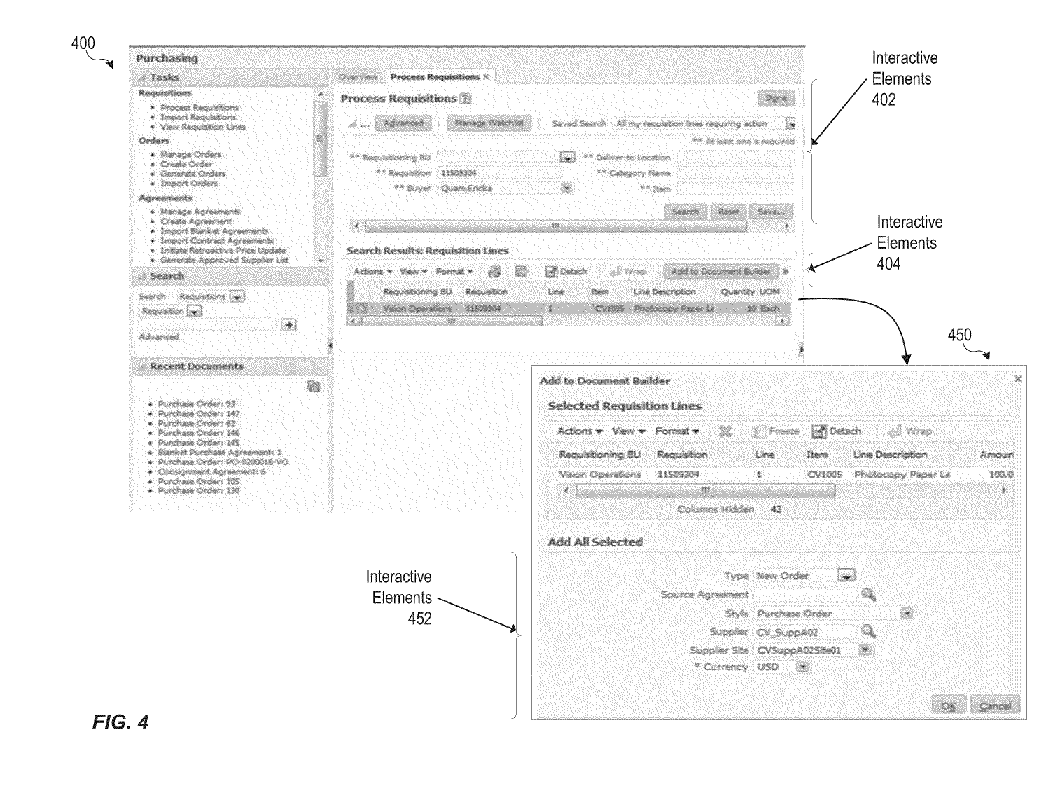

The GUI 108 can enable a user to process a purchase requisition by submitting a purchase order that can fulfill all or a portion of the purchase requisition. For example, the GUI 108 can include the GUI shown in FIG. 4, which can enable the user to specify information about a purchase order that satisfies a purchase request. Through the GUI 108, the user can provide details about the purchase order, such as one or more distributions and/or schedules for a purchase order associated with a purchase requisition.

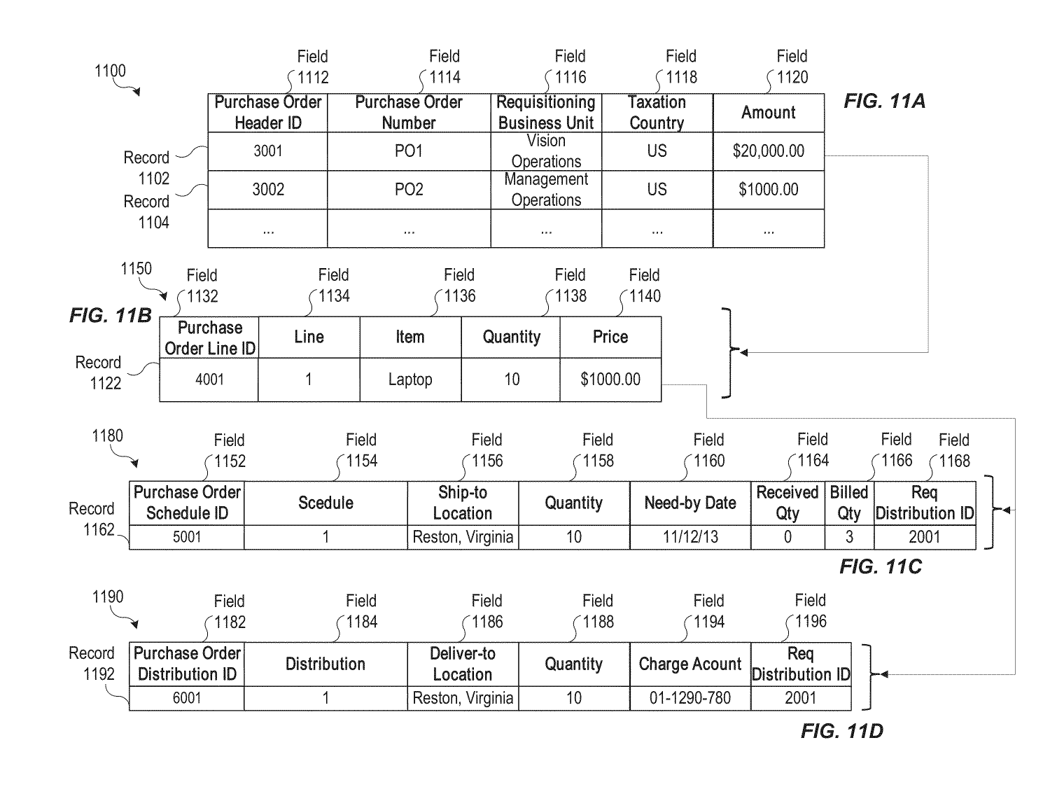

The procurement module 102 can receive the input that includes the purchase order information. The record management unit 116 can generate one or more records for a purchase order identified in the purchase order information. A purchase order can include details about distribution of one or more items (e.g., a good or a service) identified in the purchase order. Each purchase order line can have one or more schedules and one or more distributions for delivery of an item to a requisitioning business (e.g., a buyer) identifier in the purchase requisition. Further details about store of purchase order information are described with reference to FIGS. 11A-11C.

The procurement module 102 can store information about a purchase order in association with a related purchase requisition. To enable a user to efficiently and accurately assess the status of a purchase requisition, it may be desirable for the user to be able to locate pending purchase orders and their associated schedules to determine when particular items in the purchase requisition can be satisfied by completion of a purchase order. To make this possible, the record management unit 116 can store specific portions of information about a purchase order in association with a requisition ID, as explained above. For example, the procurement module 102 can store each distribution and each schedule for a purchase order in association with a requisition ID for a line corresponding to an item in a purchase requisition. In this manner, the procurement module 102 can easily identify distributions and/or schedules that correspond to a purchase requisition.

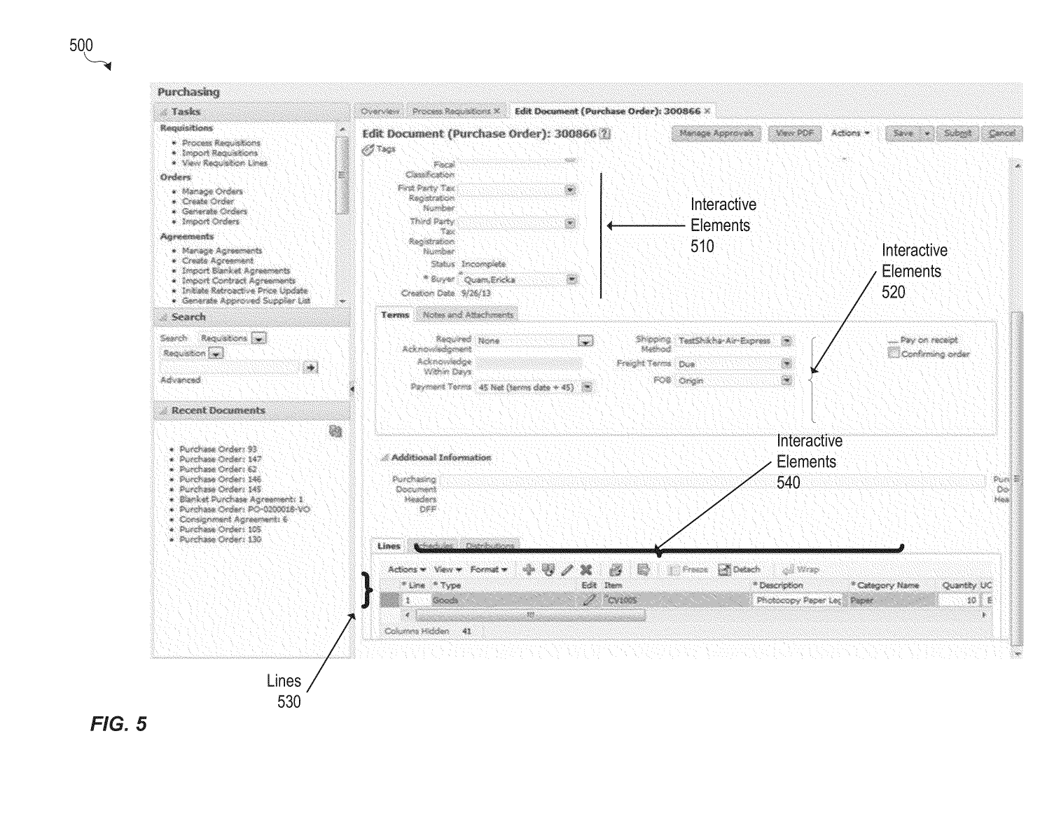

A user can view the GUI 108 to determine information related to a purchase requisition. The GUI 108 can include any of the GUIs shown in FIGS. 5-7, which can present information related to a purchase requisition. In particular the GUIs in FIGS. 5-7 can enable a user (e.g., a buyer) to make further changes such as split schedules based on suppliers request or change distribution information based on requesters information. Using the requisition ID that is stored for the purchase requisition, the storage and retrieval unit 112 can obtain information about schedules and/or distribution of each item identified in the purchase requisition. The storage and retrieval unit 112 can search the data store 170 for records with scheduling information associated with the purchase order. Information from records that include the requisition ID can be presented in the GUI 108.

The GUI 108 can enable the user to split or separate a distribution and/or schedules for a purchase order. In particular, the GUI 108 can enable the user to specify criteria for each distribution and/or schedule. Each of the different distributions and/or schedules can be separated or split. In the event that a distribution and/or a schedule are split, the record management unit 116 can create a new record for each different distribution and/or schedule, respectively. Alternatively, the record management unit 116 can modify an existing record based on the separation of distributions and/or schedules and create additional records for items that are being distributed differently or items that have different schedules. To ensure that each different distribution and/or schedule can be identified in association with an original purchase requisition, the procurement module 102 can store the requisition ID for the original purchase requisition with the record for each different distribution and/or schedule. By doing so in this manner, the storage and retrieval unit 112 can quickly locate upon request distributions and/or schedules of a purchase order fulfilling a purchase requisition.

In certain embodiments, the GUI 108 can present a user with options to search for purchase order information for a particular purchase requisition. Via the GUI 108, the procurement module 102 can receive input identifying criteria to search for one or more purchase requisitions. Through the GUI 108, a user can specify a purchase requisition and can be presented with information about each purchase order in connection with the purchase requisition. The information about each purchase order can include each different distribution and/or each different schedule, such as each new distribution and/or each new schedule. To identify the purchase order information, the storage and retrieval unit 112 can reference records for a purchase requisition to determine a requisition identifier for each purchase requisition that satisfies the criteria. Based on the purchase requisitions that are identified, the storage and retrieval unit 112 can search the record(s) of each purchase requisition to identify one or more records storing information about a purchase order. Specifically, information about each purchase requisition line in a purchase requisition can be stored in a record that includes information identifying a record storing information about a purchase order line that, if completed, will satisfy the purchase requisition. The storage and retrieval unit 112 can identify one or more records for requisition distribution identified based on the purchase requisition line. By matching a requisition distribution ID that is stamped on the purchase order distribution, the storage and retrieval unit 112 can retrieve fulfillment information for a given requisition or a given requisition line.

Alternatively or additionally, records for each of the purchase requisition lines can identify additional records that store information about distribution for each purchase requisition. The requisition ID for a purchase requisition can be distinct for each purchase requisition. Each requisition line can be associated with a requisition line ID. As such, information stored for each distribution of a purchase requisition line can be stored in association with the requisition line ID for the purchase requisition line. The storage and retrieval unit 112 can search storage for purchase order distributions that are stored in association with the requisition distribution ID (associated with a purchase requisition distribution for a purchase requisition line). The requisition distribution ID enables the storage and retrieval unit 112 to find purchase order distributions and/or schedules, including those that have been split or created. The distribution information about each purchase requisition line and the associated purchase order distribution s can be presented in the GUI 108 to the user in response to the search request.

In certain embodiments, a user can provide information identifying a new purchase order or information modifying an existing purchase order, either of which can be associated with an existing purchase requisition. Via the GUI 108, the user can provide one or more new distributions and/or schedules associated with the new or modified purchase order. As such, the procurement module 102 can receive this information provided by the user. In response to a new purchase order, the procurement module 102 can generate one or more records to store the new distributions and/or schedules related with the new purchase order. For an existing purchase order, the procurement module 102 can determine existing records and modify the existing records to indicate the new purchase order. In the event that new records are generated for a new purchase order, the one or more new distributions and/or schedules can be stored in association with an original requisition ID for a purchase requisition associated with an existing purchase requisition.

The system 100 eases management of purchase requisitions by enabling tracking of modified or split distribution for purchase orders for a purchase requisition. By storing a purchase requisition reference (e.g., a requisition distribution ID) with new distributions and/or schedules for a purchase order, the system 100 can provide a use, such as a procurement administrator, to accurately determine a total amount or quantity of an item that has been received, invoiced, and/or delivered for a purchase requisition. Using references from a purchase requisition, a disclosed system can keep track of purchase order distribution associated with distribution for the purchase requisition. The use of references to the purchase requisition helps a user to obtain information to precisely map a requisition lifecycle to receipts, invoices, and/or deliveries for original requested items in a purchase requisition. The benefits can improve productivity for procurement operations and/or supply chain systems, where tracking purchase requisitions is key.

FIGS. 2-9 showing various GUIs will be described according to some embodiments of the present invention. In some embodiments, the GUIs shown in FIGS. 2-9 can be generated and displayed by the display unit 114 of FIG. 1. For example, one or more of the GUIs in FIGS. 2-9 can be included in the GUI 108. Alternatively or additionally, one or more of the GUIs in FIGS. 2-9 can be included in the GUI 150 at the display device 140.

In FIG. 2, a GUI 200 is shown according to some embodiments of the present invention. Specifically, the GUI 200 can enable management of information related to procurement. For example, the GUI 200 shown can receive from input indicating information specifying details about a purchase requisition.

The GUI 200 can enable presentation of one or more interactive elements to receive input for creating a purchase requisition. The one or more interactive elements can receive input information 202, cost information 204, delivery information 206, request information 208, purchase order information 210, billing information 212, tax information 214, or a combination thereof. In certain embodiments, the computing device 106 can receive all or a portion of the information 202-214.

The item information 202 can include a type of item (e.g., line type) that can be a good or a service. The item information can include an item identifier (item ID), a revision number (e.g., a number indicating version of the purchase requisition), an item description, a category that the item belongs to, or a combination thereof. The cost information 204 can specify details such as a quantity of the good for purchase, a price per quantity, a currency, or a combination thereof.

The delivery information 206 can include information related to delivery of a good/service for requisition. For example, the delivery information can include a type of delivery location (e.g., internal within an organization or external to the organization), a delivery location (e.g., a deliver-to location), a delivery address, a destination type, or a combination thereof.

The request information 208 can include information related to a request associated with the purchase requisition to be created. For example, the request information 208 can include one or more requestors, an indication of urgency, a request date (e.g., a need-by date), one or more suggested buyers, or a combination thereof.

The purchase order information 210 can include information related to criteria for a purchase order that fulfills a purchase requisition that is to be created. A purchase order that satisfies the purchase requisition can be determined based on the criteria. For example, the purchase order information 210 can include an agreement type (e.g., a type of agreement requested for the purchase order), one or more suppliers, one or more suppliers sites, contact information (e.g., a name of a person associated with a supplier, a phone number, an email address, etc.) for each supplier, a supplier item that satisfies a good indicated in the purchase requisition. In some embodiments, the purchase order information 210 can include information indicating an existing purchase order that can satisfy the purchase requisition.

The billing information 212 can include billing information for the purchase requisition. The billing information can indicate cost details include a type of expenditure, an organization responsible for the expenditure, details about one or more charge accounts responsible for the purchase requisition, or a combination thereof.

The tax information 214 can include tax related information for the new purchase requisition to be created. The tax information 214 can include a transaction business category, a product type, a product classification, a product category, other tax related information, or a combination thereof.

In certain embodiments, the input provided via the GUI 200 can be received by the computing system 106. In particular, the display unit 114 can generate the GUI 200. All or a portion of the information 202-212 can be received by the procurement module 102. The information 202-214 received can be provided to the record management unit 116 to generate one or more records for each purchase requisition indicated by the information. Each generated record can be associated with a requisition ID. The generated records can be stored in the data store 170 by the storage and retrieval unit 112.

Now turning to FIG. 3, a GUI 300 is shown according to some embodiments of the present invention. Specifically, the GUI 300 can enable management of information related to procurement. For example, the GUI 300 shown can receive input indicating information specifying details about an existing purchase requisition. The GUI 300 can receive input indicating information to change for an existing purchase requisition.

The GUI 300 can present one or more interactive elements to receive input indicating information to modify for an existing purchase requisition. The GUI 300 can enable receipt of input indicating a requisition identifier associated with an existing purchase requisition. Alternatively or additionally, the GUI 300 can be presented in response to receiving input from another GUI that enables a user to specify a purchase requisition. In the GUI 300, a requisition ID 332 associated with a purchase requisition can be shown. The GUI 300 can include one or more interactive elements for implementing operations to submit one or more of the requisition lines 304 for processing by the procurement module 102.

The GUI 300 can present information related to a purchase requisition associated with the requisition ID 302. The information presented in the GUI 300 can include all or a portion of the information 202-212 received via the GUI 200 for the purchase requisition. The information presented in the GUI 300 can be obtained for one or more records associated with the requisition ID 302. The GUI 300 can present one or more requisition lines 304 (e.g., entries or records), each associated with one or more records stored for the purchase requisition associated with the requisition ID. Each of the requisition lines 304 can present information descriptive of a purchase requisition for a good/service that is requested.

The GUI 300 can include one or more interactive elements that enable receive of input related to the purchase requisition identified by the requisition ID 302. For example, the one or more interactive elements can include an interactive element for each of the requisition lines 304. The one or more interactive elements for the requisition line 304 can enable receipt of input to modify a requisition line in a purchase requisition associated with the requisition ID 302.

Now turning to FIG. 4, a GUI 400 is shown according to some embodiments of the present invention. Specifically, the GUI 400 can enable management of information related to procurement. For example, the GUI 400 can receive input to search for purchase requisitions that are being processed. The GUI 400 can enable a user to provide information about a purchase order that is for satisfaction of a purchase requisition.

The GUI 400 can include a set of interactive elements 402 that can enable search criteria to be specified for locating purchase requisitions that are being processed. The set of interactive elements 402 can include an interactive element for receiving an original requisition ID. One or more purchase requisitions that satisfy the search criteria can be presented in the GUI 400. The GUI 400 can include a set of interactive elements 404 for performing one or more functions with respect to one or more of the purchase requisitions that are presented in the GUI 400. The one or more functions can include creating a purchase order for fulfillment of a purchase requisition. Interaction with one of the set of interactive elements 404 can cause a GUI 450 to be displayed. The GUI 450 can receive input for specifying a purchase order. The GUI 450 can include a set of interactive elements 452 that receive input for creating a new purchase order for one or more requisition lines or, add one or more requisition lines to an existing purchase order.

FIGS. 5-7 show some embodiments of a GUI 500, 600, 700, respectively, according to the present invention. Specifically, the GUIs 500, 600, 700 enable a user to view and/or edit a purchase order including information related to distribution for the purchase order. Specifically, the GUIs 500, 600, 700 enable a user to make further changes such as split schedules based on suppliers request or change distribution information or schedules based on requesters information. Each of the FIGS. 5-7 include interactive elements 510, 520, 530 to receive input to edit a purchase order. The interactive elements 510 can enable a user to specify financial and/or tax information about a purchase order. The interactive elements 520 can enable a user to specify terms for a purchase order. For example, the terms can include an option for indicating whether acknowledgment is necessary for the purchase order, a number of days when acknowledge is required, payment terms, a shipping method, freight terms, a free on board (FOB) option, a payment on receipt option, a confirmation option, or a combination thereof.

Each of the GUIs 500, 600, 700 can include a set of interactive elements 540 that can cause information related to a purchase order to be displayed. The set of interactive elements 540 can include interactive elements for specifying one or more operations to be performed for the information (e.g., “Lines”, “Schedules”, and “Distributions”) displayed in association with the set of interactive elements 540. The one or more operations can include formatting, modifying a view of the information related to the purchase order, deleting information (e.g., one or more lines, one or more distributions, or one or more schedules) related to a purchase order.

In FIG. 5, the GUI 500 can present one or more lines 530 in a purchase order. Each of the one or more lines 530 can present information descriptive of each line in a purchase order identified in the GUI 500. Interaction with one of the set of interactive elements 540 can cause the one or more lines 530 to be displayed.

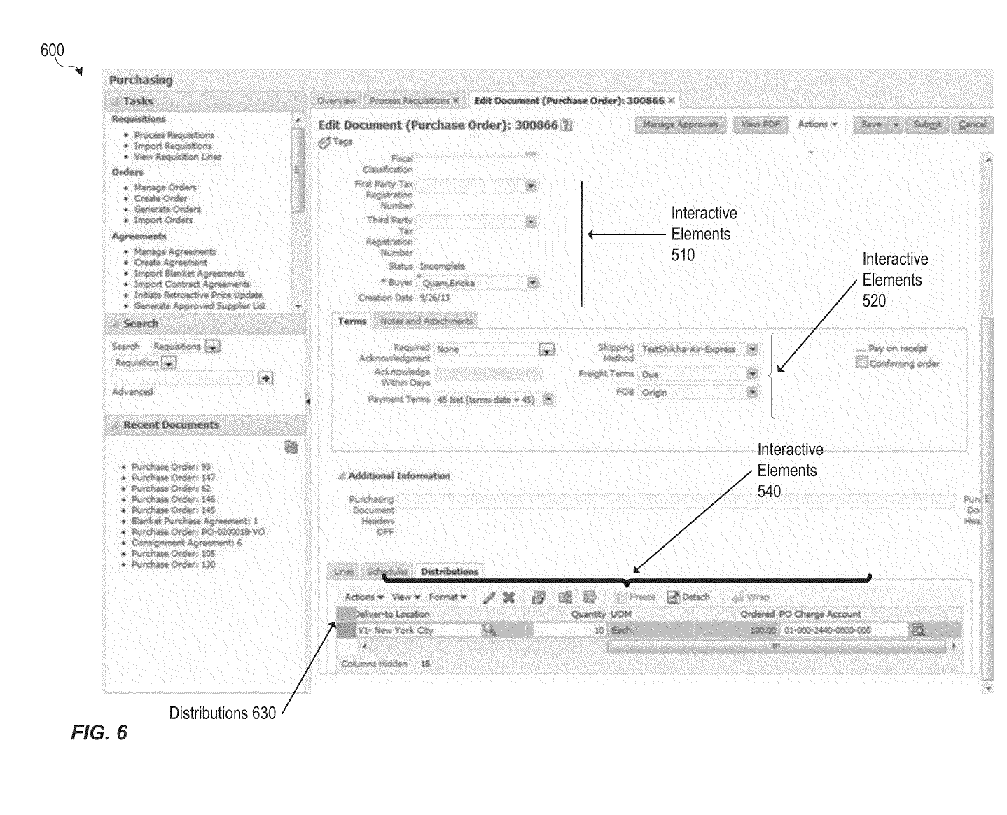

Now turning to FIG. 6, in some embodiments, interaction with one of the set of interactive elements 540 can cause one or more distributions 630 for a purchase order (identified in the GUI 600) to be displayed. Each of the one or more distributions can be associated with a schedule for the purchase order. The one or more distributions 630 can be associated with an original requisition ID of a purchase requisition being fulfilled by the purchase order shown in the GUI 600. In certain embodiments, the original requisition ID can be shown in the GUI 600 with each of the distributions that are displayed.

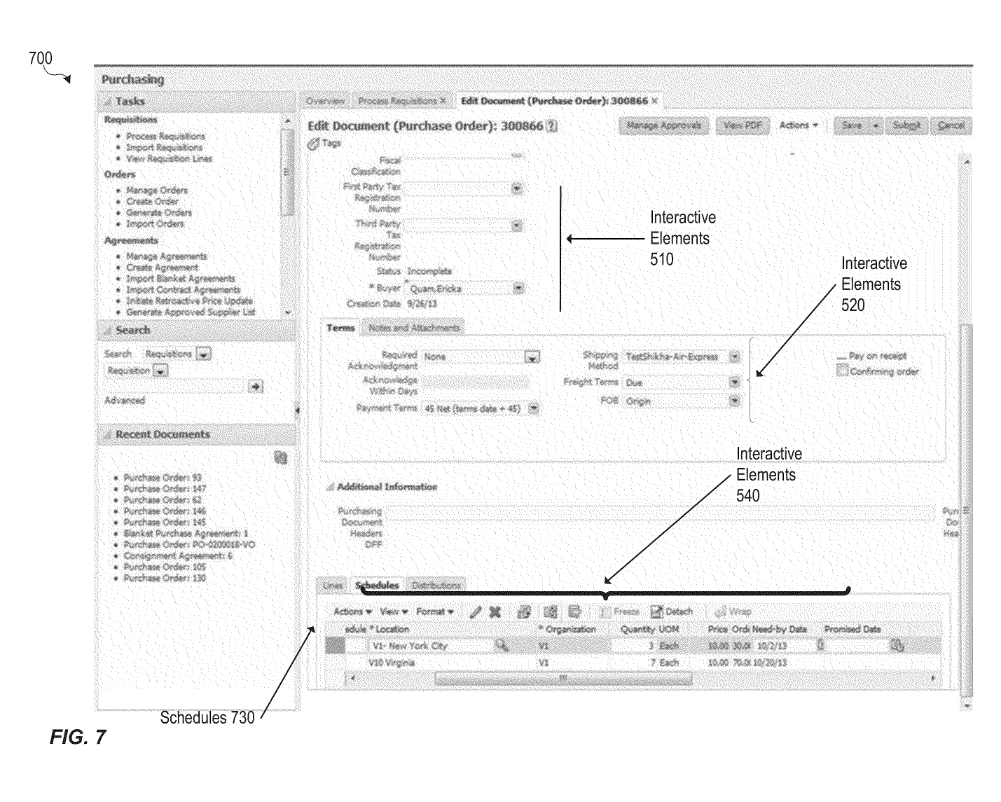

Now referring to FIG. 7, in some embodiments, interaction with one of the set of interactive elements 540 can cause one or more schedules 730 associated with a purchase order (identified in the GUI 700) to be displayed. Each of the one or more schedules can be associated with a schedule stored in a record associated with the purchase order. The one or more schedules 730 can be associated with an original requisition ID of a purchase requisition being fulfilled by the purchase order shown in the GUI 700. In certain embodiments, the original requisition ID can be shown in the GUI 700 with each of the schedules that are displayed.

An interactive element in the one or more interactive elements 740 can enable a schedule of the one or more schedules 730 to be split or separated into multiple different schedules for distribution. For example, as shown in FIG. 7, a schedule for delivery of an item having a quantity of 10 is shown as split into two different schedules. A quantity of 3 for the item will be shipped to a location in “New York City” and a quantity of “7” will be shipped to “Virginia”. Although not shown, each of the schedules can be displayed with an original requisition ID associated with a purchase requisition that is being satisfied. In this example, each schedule for the item will be delivered to a different location according to a different need-by-date. Each of the schedules 730 can be stored in a record in association with an original requisition ID of a purchase requisition that would be satisfied by completion of the schedules 730.

Now turning to FIG. 8, a GUI 800 is shown according to some embodiments of the present invention. Specifically, the GUI 800 can enable management of information related to procurement. For example, the GUI 800 can receive input to search for purchase requisitions that are being processed. The GUI 800 can display search one or more search results for purchase requisitions that satisfy search criteria.

The GUI 800 can include one or more interactive elements 810 to receive search criteria to for locating one or more purchase requisitions that are being processed. The set of interactive elements 802 can include an interactive element for receiving an original requisition ID. One or more purchase requisitions that satisfy the search criteria can be presented in the GUI 800. For example, the GUI 800 can display results, such as purchase requisition 820. Each result can include an original requisition ID associated with the purchase requisition. Each result can include a purchase order if one exists. The information displayed in the GUI 800 can include information stored in one or more records for a purchase requisition and associated purchase orders.

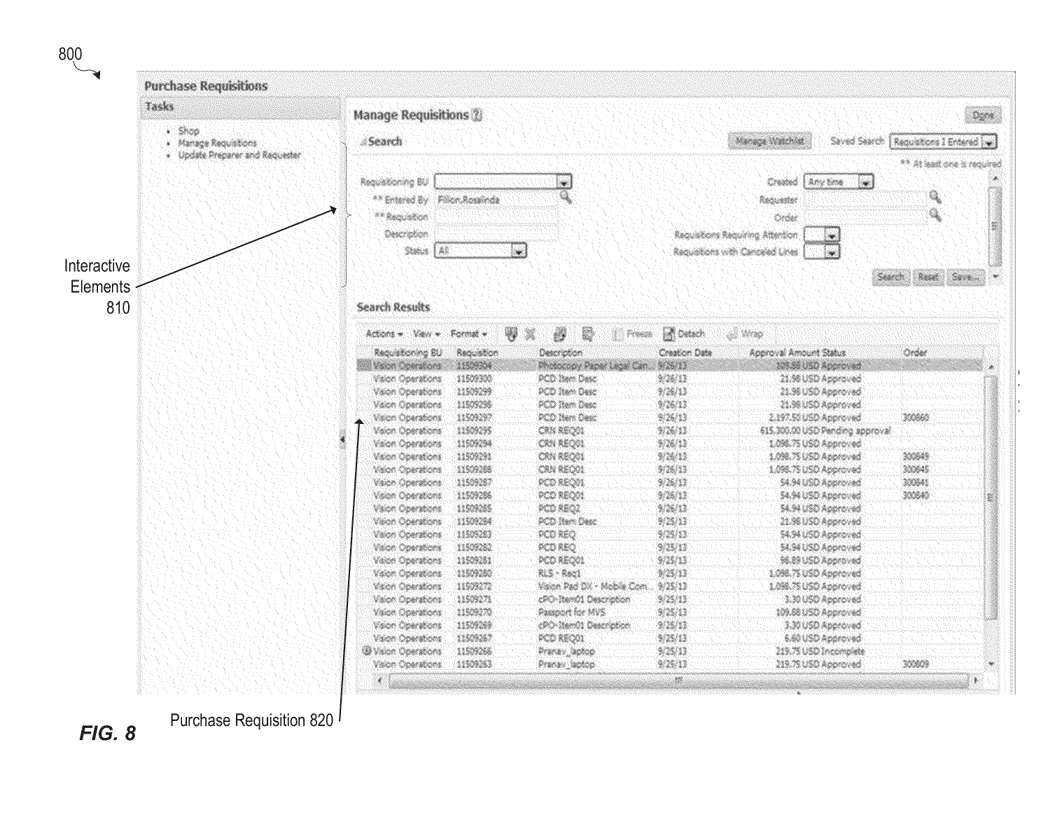

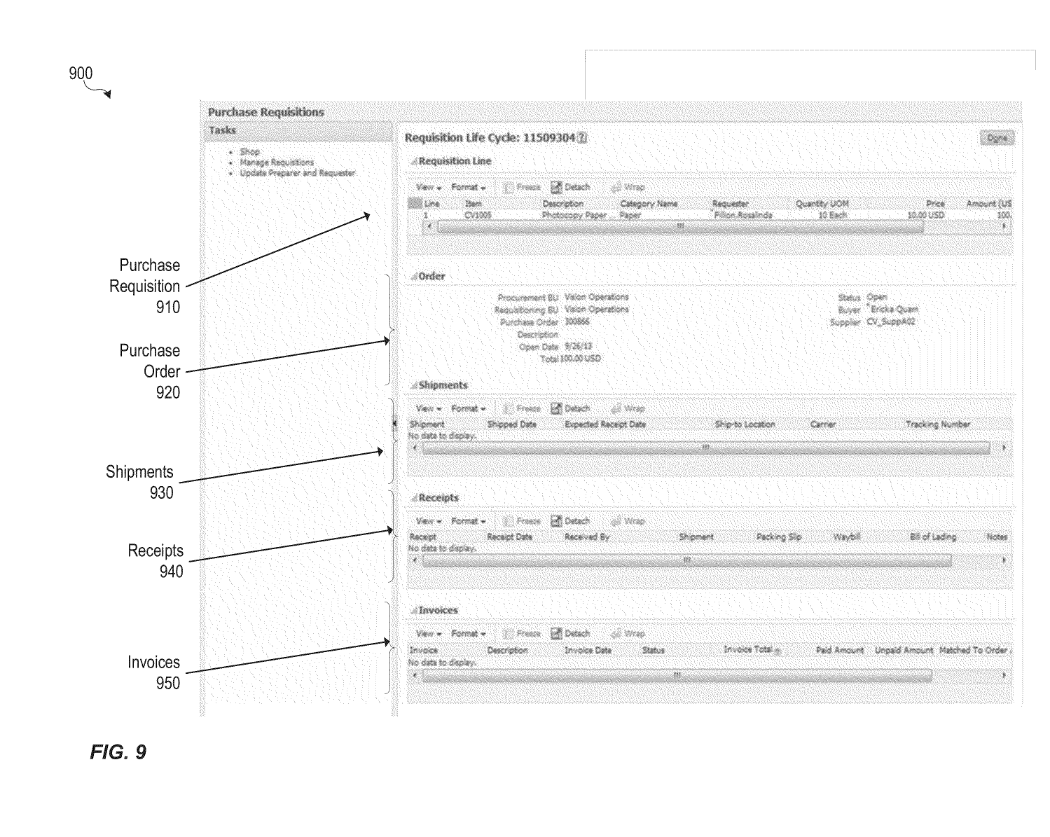

In certain embodiments, each of the results in FIG. 8 can be associated with an interactive element that cause a different GUI, such as a GUI 900 in FIG. 9, to be displayed with detailed information about the purchase requisition. Now turning to FIG. 9, the GUI 900 is shown according to some embodiments of the present invention. The GUI 900 can present information descriptive of a life cycle of a purchase requisition (requisition life cycle) chosen from the results in the GUI 800.

The GUI 900 can include one or more interactive elements that are presented with information descriptive of a purchase requisition 910 chosen for the GUI 900. Information associated with procurement of items in the purchase requisition 910 can be presented in the GUI 900. The GUI 900 can include information descriptive of purchase order(s) 920 associated with the purchase requisition 910, one or more shipments 930 associated with the purchase requisition 910, one or more receipts 940 associated with the purchase requisition 910, one or more invoices 950 associated with the purchase requisition 910.

The information displayed in the GUI 900 can be obtained from one or more records stored for the purchase requisition 910, or stored in association with a purchase order that satisfies the purchase requisition 910. For example, a purchase order shown by the purchase order 920 can be obtained from one or more records associated with a purchase order identified using an original requisition ID for the purchase requisition 910.

Now turning to FIGS. 10A-10C, data structures 1000, 1050, and 1080 are shown according to some embodiments of the present invention. The data structures 1000, 1050, 1080 are representative of one or more data structures that the procurement module 102 of FIG. 1 can create and manage to store records including information related to procurement. In particular, each of the data structures 1000, 1050, 1080 can manage one or more records for information related to purchase requisitions.

In certain embodiments, the data structure 1000 can store information descriptive of one or more purchase requisitions. For example, the data structure 1000 can store one or more records, such as record 1002 and record 1004. Each record can store a purchase requisition header that can provide information about a purchase requisition. A purchase requisition header can correspond to information in a distinct document (e.g., a purchase requisition) that identifies one or more purchase requisitions, such as a group of purchase requisitions. A purchase requisition header can include a requisition number, a business unit that requests a purchase requisition, a business unit that receives a purchase requisition, tax information about a purchase requisition, an amount of the purchase requisition. To illustrate, each record in the data structure 1000 can store one or more fields about a purchase requisition, such as a field 1012 that includes a requisition header identifier (req header ID), field 1014 that includes a requisition number, field 1016 that includes a requisitioning business unit, field 1018 that includes a taxation country, and field 1020 that includes an amount for a purchase requisition.

FIG. 10A shows an example of contents in the data structure 1000. The record 1002 can contain information descriptive of a first purchase requisition identified by a requisition header ID 1012 having a value of “0001.” The record 1002 can include details about the purchase requisition “0001,” such as a requisition number in field 1014 having a value of “REQ1,” a requisitioning business unit in field 1016 having a value of “vision operations,” a taxation country in field 1020 having a value of “US,” and an amount of money available for the purchase requisition in field 1020 having a value of “$20,000”. The record 1004 can contain information descriptive of a second purchase requisition identified by a requisition header ID 1012 having a value of “0002.” The record 1004 can include details about the purchase requisition “0002,” such as a requisition number in field 1014 having a value of “REQ2,” a requisitioning business unit in field 1016 having a value of “management operations,” a taxation country in field 1020 having a value of “US,” and an amount of money available for the purchase requisition in field 1020 having the value of “$1,000”. Each of the purchase requisitions, “REQ1” and “REQ2” can include one or more purchase requisitions lines as shown in a data structure 1050 of FIG. 10B.

Now turning to FIG. 10B, in certain embodiments, the data structure 1050 can store information descriptive of one or more distinct purchase requisition lines associated with a purchase requisition. The purchase requisition can correspond to a distinct purchase requisition header in the data structure 1000. For example, the data structure 1050 can store information descriptive of each purchase requisition associated with a distinct purchase requisition header indicated in record 1002. The procurement module 102 can generate and manage a plurality of data structures, such as data structure 1050, for each purchase requisition identified in the data structure 1000.

The data structure 1050 can include one or more records, such as record 1022 and record 1024. Each record in the data structure 1050 can correspond to a purchase requisition line in a purchase requisition. For example, the data structure 1050 can store the record 1022 and the record 1024, each corresponding to a purchase requisition line in the purchase requisition identified in record 1002 of FIG. 10A. A purchase requisition line can include a requisition line identifier (req line ID), a line number, an item (e.g., a good or a service), a quantity of the item, a price of the item, a need-by-date, and a PO line indicating a corresponding purchase order line associated with the purchase requisition line. In some embodiments, when a purchase requisition is created, the information for the PO line can be empty until the requisition is approved by requesting organization and the purchase requisition is converted into a purchase order. The PO line can be populated with information indicating a reference to the PO.

However, the information in a purchase requisition line is not limited the description herein. In the data structure 1050, each record can store one or more fields about a purchase requisition line, such as a field 1032 that includes a requisition line ID, a field 1034 that includes a line number, a field 1036 that includes an item (e.g., a good), a field 1038 that includes a quantity of the item, a field 1040 that includes a price and field 1020 that includes an amount for a purchase requisition.

FIG. 10B shows an example of contents in the data structure 1050. The record 1022 can contain information descriptive of a first purchase requisition line associated with the purchase requisition identified by “REQ1” in the record 1002. The first purchase requisition line in the record 1022 can be identified by a requisition line ID 1032 having a value of “1001.” The record 1022 can include information about the purchase requisition line “1001,” such as a line number in field 1034 having a value of “1,” an item in field 1036 having a value of “laptop,” a quantity of the item in field 1038 having a value of “10,” a price of the item in field 1040 having a value of “$1000.00,” a need-by-date in the field 1042 having the value of “11/12/13,” and a PO line ID in the field 1044 having the value of “4001.” The record 1024 can contain information descriptive of a second purchase requisition line associated with the purchase requisition identified in the record 1002. The second purchase requisition line in the record 1024 can be identified by a requisition line ID 1032 having a value of “1002.” The record 1024 can include information about the purchase requisition line “1002,” such as a line number in field 1034 having a value of “2,” an item in field 1036 having a value of “mobile device,” a quantity of the item in field 1038 having a value of “100,” a price of the item in field 1040 having a value of “$100.00,” a need-by-date in the field 1042 having the value of “11/12/13,” and a PO line ID in the field 1044 having no value. Each of the purchase requisition lines, “1” and “2” can include one or more purchase requisitions distributions, each corresponding to a purchase requisition distribution, as shown in the data structure 1080 of FIG. 10C. In certain embodiments, the field 1044 can have a value indicating a PO line ID corresponding to a purchase order line in a purchase order, if one exists, which satisfies the purchase requisition for the purchase requisition line “2”.

Now turning to FIG. 10C, in certain embodiments, the procurement module 102 can generate and manage one or more data structures (e.g., the data structure 1080) with information descriptive of distribution information for a purchase requisition. For example, the data structure 1080 can store one or more records, each including information descriptive of distribution for a purchase requisition line in a record of the data structure 1050. To illustrate, in FIG. 10C, the data structure 1080 can include a record 1062 that stores information about distribution for an item for requisition identified in line “1” of the data structure 1050. Each record in the data structure 1080 can correspond to a purchase requisition distribution for a purchase requisition line in a purchase requisition. In the data structure 1080, each record can store one or more fields about a purchase requisition distribution, such as a field 1052 that includes a requisition distribution ID (e.g., a value of “2001”), a distribution number (e.g., a value of “1”), a delivery location (e.g., a value of “Reston, Virginia”), a quantity to be delivered (e.g., a value of “10”), and a charge account to charge for the distribution (e.g., a value of “01-129-780”).

The procurement module 102 can generate an original requisition distribution ID that is associated with a requisition distribution for an item specified for a purchase requisition line in a purchase requisition. For example, a requisition distribution ID be stored in a field 1052 of a record (e.g., the record 1062) of the data structure 1080. The requisition distribution ID can be used to associate purchase order distribution information, if present, with the purchase requisition distribution information. Thus, by associating the requisition distribution ID with purchase order information, the procurement module 102 can identify distribution information for a purchase order, if one exists, to determine a status of requisition for an item.

FIGS. 11A-11D show data structures according to some embodiments of the present invention. The data structures 1100, 1122, 1162, and 1992 are representative of one or more data structures that the procurement module 102 of FIG. 1 can use to store records including information related to procurement. In particular, each of the data structures 1100, 1122, 1162, and 1192 can store one or more records for information related to purchase orders.

Now referring to FIG. 11A, in certain embodiments, the data structure 1100 can store information descriptive of one or more purchase orders. For example, the data structure 1100 can store one or more records, such as record 1102 and record 1104. Each record can store a purchase order header that can provide information about a purchase order. In some embodiments, a purchase order header can correspond to information in a distinct document (e.g., a purchase order agreement) that identifies one or more purchase orders, such as a group of purchase orders. A purchase order header can include a purchase order number, a business unit that requests a purchase requisition, a requisitioning business unit (e.g., a business unit that issues a purchase requisition to be satisfied by the purchase order), tax information about the purchase requisition, an amount of the purchase requisition. To illustrate, each record in the data structure 1100 can store one or more fields about a purchase order, such as a field 1112 that includes a purchase order header identifier (purchase order header ID), a field 1114 that includes a purchase order number, a field 1116 that includes a requisitioning business unit, a field 1118 that includes a taxation country for a purchase requisition, and a field 1120 that includes an amount for a purchase requisition.

FIG. 11A shows an example of contents in the data structure 1100. The record 1102 can contain information descriptive of a first purchase order identified by a purchase order header ID 1112 having a value of “3001.” The record 1102 can include details about the purchase order “3001,” such as a purchase order number in field 1114 having a value of “PO1,” a requisitioning business unit in field 1116 having a value of “vision operations,” a taxation country in field 1120 having the value of “US,” and an amount of money available for the purchase requisition in field 1120 having a value of “$20,000.” The record 1104 can contain information descriptive of a second purchase order identified by a purchase order header ID 1112 having a value of “3002.” The record 1104 can include details about the purchase order “3002,” such as a purchase order number in field 1114 having a value of “PO2,” a requisitioning business unit in field 1116 having a value of “vision operations,” a taxation country in field 1120 having the value of “US,” and an amount of money available for the purchase requisition in field 1120 having a value of “$20,000.” Each of the purchase orders “PO1” and “PO2,” can include one or more purchase orders, each corresponding to a purchase order line, as shown in the data structure 1150 of FIG. 11B.

FIG. 11B shows an example of contents in the data structure 1150. The data structure 1150 can contain one or more records, each containing information descriptive of a purchase order line associated with a purchase order identified in the data structure 1100. Each purchase order line can contain information about a purchase order for an item in a purchase requisition. In some embodiments, a purchase order line identified in a record of the data structure 1150 can contain information similar to a purchase requisition line in a record of data structure 1050 of FIG. 10B. A purchase order line can represent a purchase order for an item in a purchase requisition identified by a purchase requisition line. Further, when a purchase order line exists for a purchase requisition line, the field 1044 in FIG. 10B can have a value indicating a PO line ID corresponding to a purchase order line. In the example in FIGS. 10B and 11B, the field 1044 has the PO line ID of “4001” corresponding to the purchase order line in record 1122 associated with the purchase requisition line indicated by record 1022 in FIG. 10B.

In the data structure 1150, the record 1122 can contain information descriptive of a first purchase order line associated with the purchase order identified by “PO1” in the record 1102. The first purchase order line in the record 1122 can be identified by a purchase order line ID 1132 having a value of “4001.” The record 1122 can include information about the purchase order line “3001,” such as a line number in field 1134 having a value of “1,” an item in field 1136 having a value of “laptop,” a quantity of the item in field 1138 having a value of “10,” and a price of the item in field 1140 having a value of “$1000.00.” Each of the purchase order lines, “1,” can include one or more purchase order distributions, each corresponding to a purchase requisition distribution, as shown in data structure 1180 of FIG. 11C and data structure 1190 of FIG. 11D.

In certain embodiments, the procurement module 102 can generate and manage one or more data structures (e.g., the data structure 1180 and the data structure 1190) with information descriptive of distribution information for a purchase order. For example, the data structure 1180 can store one or more records, each including information descriptive of distribution for a purchase order line in a record of the data structure 1150. The information descriptive of distribution can provide details about distribution details of a purchase order line. In this example, the record 1162 in the data structure 1180 can provide details for a schedule of a purchase order line “1” stored in the data structure 1150. In another example, the data structure 1190 of FIG. 11D can store one or more records, each including information descriptive of one or more distributions corresponding to a purchase order schedule for a purchase order line in a record of the data structure 1150. The information descriptive of a distribution can provide details about distribution for a purchase order line. In this example, the record 1192 in the data structure 1190 can provide details for distribution of a purchase order line “1” stored in the data structure 1150.

Now referring to FIG. 11C, the data structure 1180 can include a record 1162 that stores information about distribution for an item in a purchase order identified in purchase order line “1” of the data structure 1150 of FIG. 11B. Each record in the data structure 1180 can correspond to a purchase order distribution for a purchase order line. In the data structure 1180, each record can store one or more fields about a purchase order distribution, such as a field 1152 for a purchase order schedule ID (e.g., a value of “5001”), a field 1154 for a schedule number (e.g., a value of “1”), a field 1156 for a ship-to location (e.g., a value of “Reston, Virginia”), a field 1158 for a quantity of an item to be delivered (e.g., a value of “10”), a field for 1160 a delivery date (e.g., a need-by date, such as a value of “11/12/13”), a field 1164 for a received quantity of an item to be delivered (e.g., a value of “0”), a field 1166 for a billed quantity (e.g., a value of “3”), and a field 1168 for requisition distribution ID (e.g., a value of “2001”). In the example shown in FIG. 11C, record 1162 provides information about a purchase order schedule for a purchase order line represented by record 1122.

Now referring to FIG. 11D, the data structure 1190 can include a record 1192 that stores information about distribution for an item in a purchase order identified in purchase order line “1” of the data structure 1150 of FIG. 11B. Each record in the data structure 1190 can correspond to a purchase order schedule for a purchase order line. In the data structure 1190, each record can store one or more fields about a purchase order distribution for a purchase order schedule in a record of the data structure 1180. Here, the record 1192 stores information descriptive of a purchase order distribution for a purchase order schedule in record 1162 of the data structure 1180. The record 1192 can include information such as a field 1182 that includes a purchase order distribution ID (e.g., a value of “6001”), a field 1184 for a distribution number (e.g., a value of “1”), a field 1186 for a delivery location (e.g., a value of “Reston, Virginia”), a field 1188 for a quantity of an item to be delivered (e.g., a value of “10”), a field 1190 for a charge account (e.g., a value of “01-1290-780”), and a field 1192 for a requisition distribution ID (e.g., a value of “2001”).

In certain embodiments, the procurement module 102 can store a requisition distribution ID 1192 associated with a purchase requisition distribution, in each record that stores information about a purchase order distribution for the purchase requisition. For example, a record in the data structure 1180 and/or the data structure 1190 can store a requisition ID corresponding to a purchase requisition distribution satisfies by the purchase order distribution associated with the record. For example, a record in the data structure 1190 can have a field 1198 that stores a value of a requisition distribution ID. The requisition distribution ID can correspond to field 1052 of the data structure 1080 in FIG. 10C associated with distribution information for a purchase requisition.

By storing a requisition distribution ID, with information about a purchase order distribution, the procurement management system 100 in FIG. 1 can identify purchase order distributions and/or schedules that are associated with a purchase requisition. For example, the procurement module 102 can use a requisition distribution ID of a record for distribution of a purchase requisition to identify records for a purchase order distribution (e.g., the record 1162) and a purchase order schedule (e.g., the record 1192).

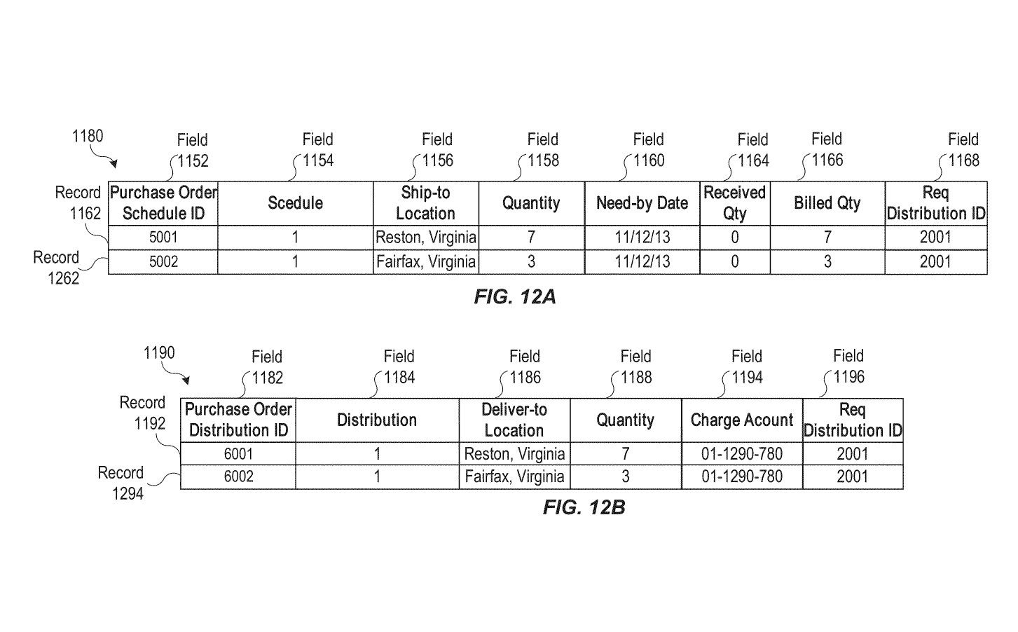

FIGS. 12A and 12B show data structures according to some embodiments of the present invention. Specifically, FIGS. 12A and 12B show records in the data structures 1180 of FIG. 11C and 1190 of FIG. 11D after a split in a schedule for a purchase order has occurred.

In the event that a schedule for a purchase order line is split, the procurement module 102 of FIG. 1 can generate one or more additional records for schedule information. Each additional record can correspond to a different schedule based on one or more parameters (e.g., shipping schedule or delivery schedule) for a schedule. For example, in the event that the schedule for the purchase order line in the record 1122 is split, the procurement module 102 can generate one or more additional records for a schedule in the data structure 1080 based on the change to a schedule for the purchase order. Each a new record can be generated for each different schedule that is determined as a result of the split. In some embodiments, one or more existing records for a schedule can be modified, while additional records can be generated for each additional schedule that is determine as a result of the split.

To illustrate a result of a split in a schedule, FIG. 12A shows a purchase order schedule split for the purchase order line associated with record 1122 of FIG. 11C. As a result of the split, the procurement module 102 generates an additional record 1262 for the data structure 1180 and updates the record 1162 based on the split. Here, the record 1162 is updated for the field 1158 to change the quantity to a value of “7” and a billed quantity of “7” because the schedule is split from “10” into “7” and “3” for the laptop in the purchase order line in record 1122. The record 1262 is an additional record created for a different schedule based on the original schedule in the record 1162 before the split. The new record 1262 can contain a new, different schedule where the ship-to location in the field 1156 has a different value of “Fairfax, Virginia,” a different quantity of “3,” and a different billed quantity of “3.” The original record 1162 remains associated with the old record 1192 for the purchase order distribution. Now referring to FIG. 12B, the procurement module 102 can update the record 1192 corresponding to the distribution change for the split. The record 1192 can be updated accordingly because of the change in the schedule for the record 1162. The record 1162 remains associated with the record 1192. The procurement module 102 can generate a new purchase order distribution stored in record 1294, which corresponds to the new record 1262 for the new schedule. The procurement module 102 can create one or more new records in the data structure 1190 for each new schedule change in the data structure 1180.

The procurement module 102 can store a requisition distribution ID (e.g., the purchase requisition ID associated with field 1052 in the data structure 1080) for each new record create in either or both of the data structure 1180 and the data structure 1190. In the example shown in FIGS. 12A and 12B, the procurement module 102 can store the requisition distribution ID in field 1196 of the record 1192 and in the field 1196 of the new record 1294. By referring back to the same requisition distribution ID for an original purchase order, the new purchase order distribution can be associated with an original backing purchase requisition. Thus, the procurement module 102 can identify records for distribution and/or schedules after a split. In this manner, the purchase order distribution after a split are stored in association with the requisition distribution ID because each record 1192 and 1294 in the data structure 1190 that is associated with a schedule in the data structure 1180 has been updated to store the requisition distribution ID. The data structure 1180 can similarly be updated to include the requisition distribution ID in each record associated with a schedule that changes (e.g., split) for a record of the data structure 1180.

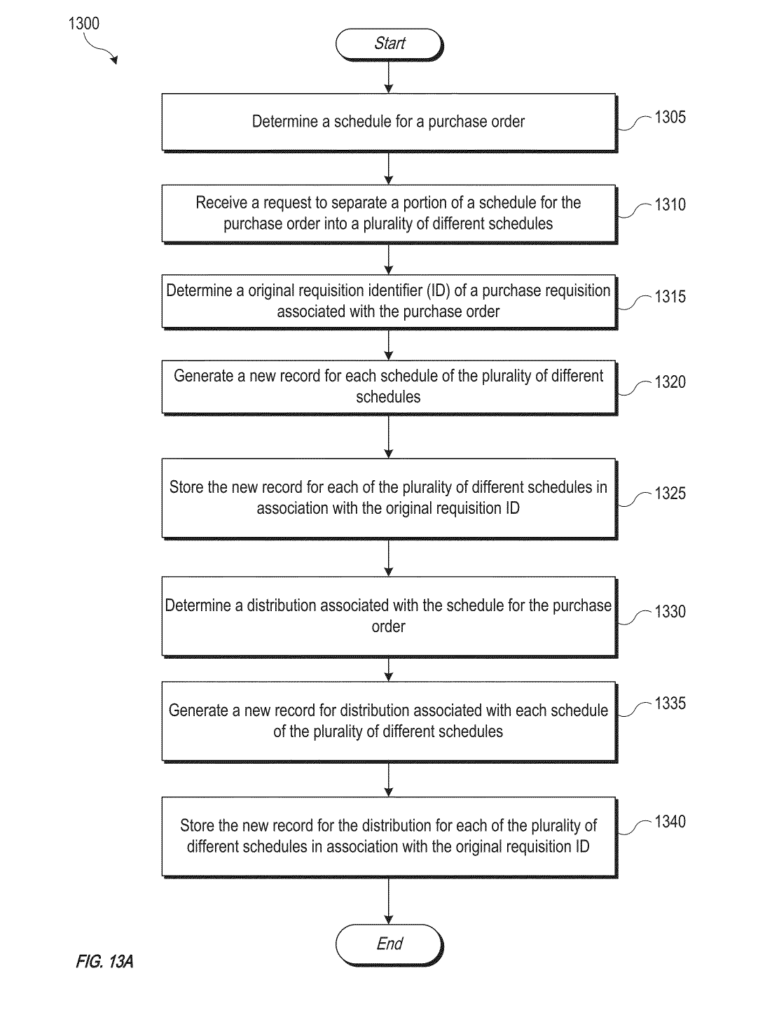

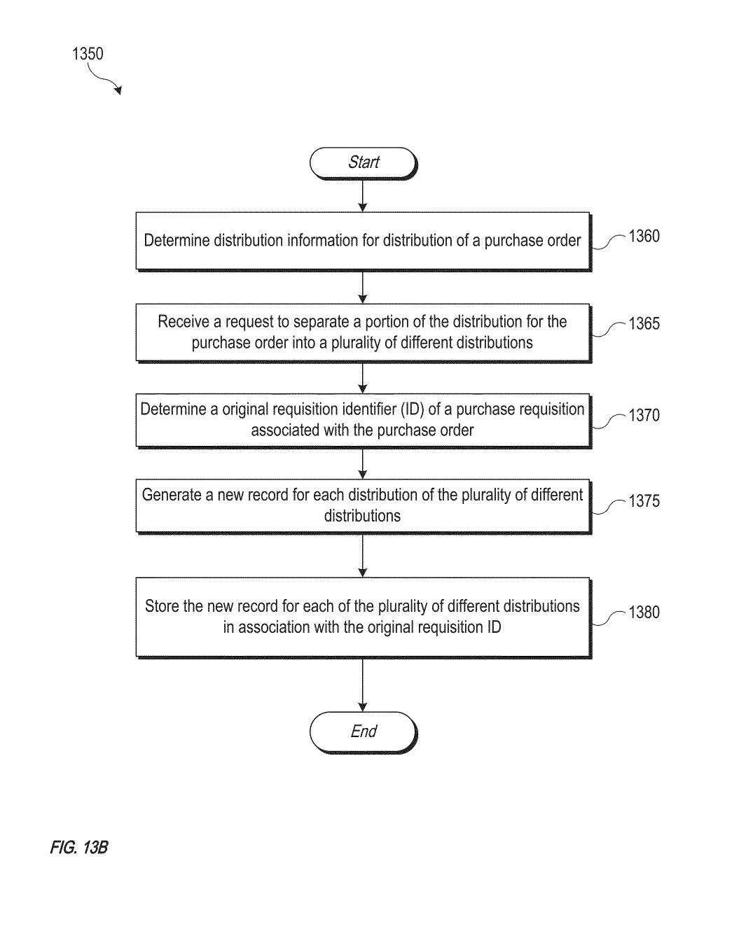

FIGS. 13A and 13B each shows a flowchart of a process 1300 according to some embodiments of the present invention. Specifically, FIG. 13A shows a technique of managing information related to schedules of one or more purchase orders associated with a purchase requisition. In certain embodiments, the process 1300 can enable management of information and relationships between split or new schedules for a purchase order fulfilling a purchase requisition. A request to split a schedule can originate from a party such as a supplier. In some embodiments, the process 1300 can be implemented by a computing system, e.g., the computing system 106 of FIG. 1.

Beginning at block 1305, the process 1300 can include determining a schedule for a purchase order. Of the many operations that can be performed by the procurement module 102, the procurement module 102 can create and manage information (e.g., records) for a purchase order associated with a purchase requisition. The procurement module 102 can search the data store 170 to determine information, such as purchase orders, associated with a purchase requisition by a requisition ID. The requisition ID can be associated with distribution for a purchase requisition by the procurement module 102. The procurement module 102 can locate one or more records (e.g., a schedule record 1162 of FIG. 11C) indicating a schedule for a purchase order.

At block 1310, the process 1300 can include receiving a request to split or separate a portion of a schedule for the purchase order into a plurality of different schedules. For example, the request can indicate that a schedule for a purchase order is to be split into multiple shipments, such as different ship-to locations and/or different delivery dates.

At block 1315, the process 1300 can include determining an original requisition distribution ID of a purchase requisition associated with a purchase order. For example, the procurement module 102 can determine the req distribution ID in field 1052 of FIG. 10C of a purchase requisition backing the purchase order for the laptop (e.g., the purchase order indicated by the records 1122). In this example, the procurement module 102 can use the record 1162 of the schedule for the laptop to obtain the requisition distribution ID in the field 1168. The requisition distribution ID identified in field 1168 corresponds to an original requisition distribution ID for the purchase requisition of the laptop identified in the record 1062. By storing distribution information, such as the schedule, with a requisition distribution ID of a purchase requisition distribution associated with the purchase order, the procurement module 102 can determine a backing purchase requisition associated with a schedule for the purchase order.

At block 1320, the process 1300 can include generating a new record for each schedule of the plurality of different schedules for the purchase order. In some embodiments, a new record can be generated for the schedule that is split into a plurality of different schedules. For example, a new schedule record (e.g., a record 1262) can be created for the split schedule. Some information which does not change as a result of the split can be copied from the record for the original schedule into the new record. The existing schedule record(s) (e.g., the record 1162) can be modified according to the changes in the one or more parameters of the split schedule.

At block 1325, the process 1300 can include storing the new record for each of the plurality of different schedules in association with the original requisition distribution ID. For example, the procurement module 102 can store the newly generated record for the new schedule (split from the original schedule for the purchase order) in association with the original requisition ID of a purchase requisition associated with the purchase order.

At block 1330, the process 1300 can include determining a distribution associated with the schedule for the purchase order. For example, the procurement module 102 can determine the record 1992 associated with the record 1162 for the schedule of a purchase order.

At block 1335, the process 1300 can include generating a record for distribution associated with each of the plurality of different schedules. For example, the procurement module 102 can generate the record 1292 for the distribution corresponding to the schedule in the record 1262. The information in the new record 1292 can include part of the information from the record 1192 for information about the distribution of the schedule that does not change. The record that is generated for the distribution associated with the new schedule is stored in associated with the requisition distribution ID stored with the new schedule. The process 1300 can include updating a record for distribution associated with the existing schedule that is separated. For example, the procurement module 102 can update the record 1192 for the distribution associated with the record 1162 for the schedule that is split.

At block 1340, the process 1300 can include storing the new record for the distribution for each of the plurality of different schedules in association with the original requisition ID. For example, the procurement module 102 can store the original requisition distribution ID in the field 1196 of the record 1292.

FIG. 13B shows a technique of managing information related to distribution of one or more purchase orders associated with a purchase requisition. In certain embodiments, the process 1350 can enable management of information and relationships between split or new distribution for a purchase order fulfilling a purchase requisition. A request to split distribution can originate from a party such as a requesting organization. In some embodiments, the process 1350 can be implemented by a computing system, e.g., the computing system 106 of FIG. 1.

Beginning at block 1360, the process 1300 can include determining distribution information for distribution of a purchase order. The procurement module 102 can search the data store 170 to locate one or more records (e.g., a distribution record 1192 of FIG. 11D) indicating a distribution associated with a schedule for a purchase order. The procurement module 102 can determine distribution information from the records for the distribution.

At block 1365, the process 1300 can include receiving a request to split or separate a portion of the distribution for the purchase order into a plurality of different distributions. For example, a request received by the procurement module 102 can indicate that a distribution for a purchase order is to be split into multiple distributions, each distribution specific to a different cost center to be billed.

At block 1370, the process 1300 can include determining an original requisition distribution ID of a purchase requisition associated with a purchase order. At block 1375, the process 1300 can include generating a new record for each distribution of the plurality of different distributions for the purchase order. In some embodiments, a new record can be generated for the distribution that is split into a plurality of different distributions. For example, a new schedule record (e.g., a record 1292) can be created for the split distribution. Some information which does not change as a result of the split can be copied from the record for the original distribution into the new record. The existing distribution record(s) (e.g., the record 1192) can be modified according to the changes in the one or more parameters of the record for distribution that is split.

At block 1380, the process 1300 can include storing the new record for each of the plurality of different distributions in association with the original requisition distribution ID. For example, the procurement module 102 can store the newly generated record for the new distribution (split from the original distribution for the purchase order) in association with the original requisition ID of a purchase requisition associated with the purchase order.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

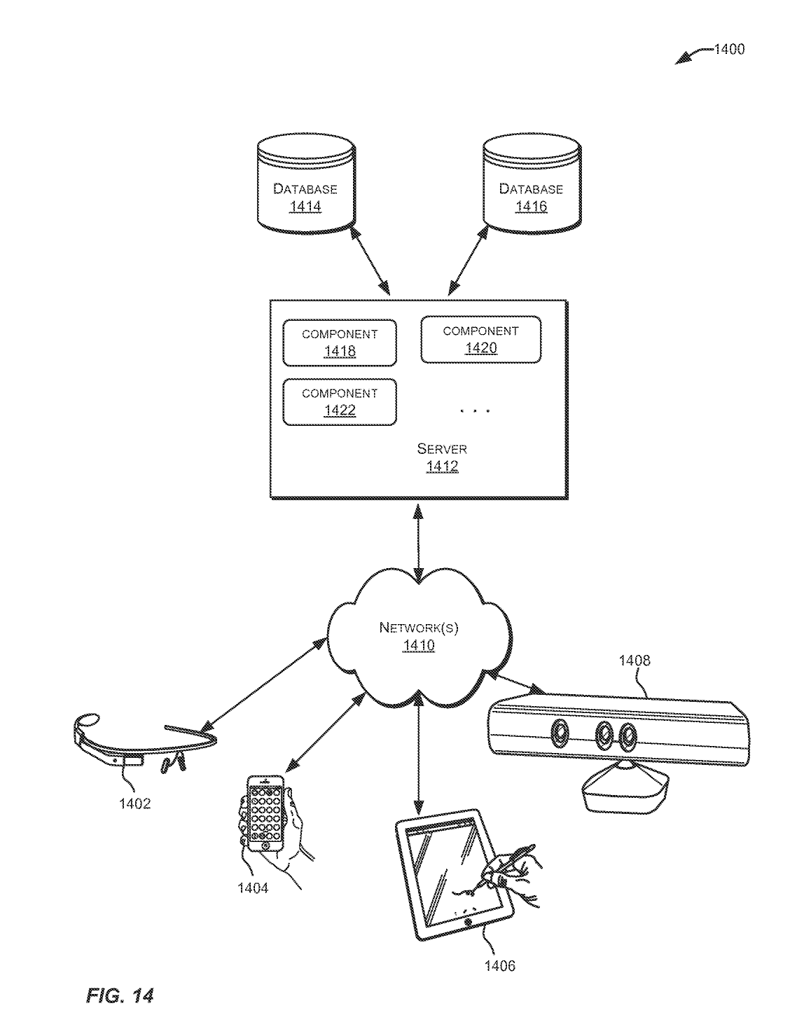

FIG. 14 depicts a simplified diagram of a distributed system 1400 for implementing one of the embodiments. In the illustrated embodiment, distributed system 1400 includes one or more client computing devices 1402, 1404, 1406, and 1408, which are configured to execute and operate a client application such as a web browser, proprietary client (e.g., Oracle Forms), or the like over one or more network(s) 1410. Server 1412 may be communicatively coupled with remote client computing devices 1402, 1404, 1406, and 1408 via network 1410. The server 1412 and/or all or any of the remote client computing devices 1402, 1404, 1406, and 1408 can be configured to implement operations described herein with reference to the disclosed figures.

In various embodiments, server 1412 may be adapted to run one or more services or software applications provided by one or more of the components of the system 1400. The services or software applications can include nonvirtual and/or virtual environments. Virtual environments can include those used for virtual events, tradeshows, simulators, classrooms, shopping exchanges, and enterprises, whether two- or three-dimensional (3D) representations, page-based logical environments, or otherwise. In some embodiments, these services may be offered as web-based or cloud services or under a Software as a Service (SaaS) model to the users of client computing devices 1402, 1404, 1406, and/or 1408. Users operating client computing devices 1402, 1404, 1406, and/or 1408 may in turn utilize one or more client applications to interact with server 1412 to utilize the services provided by these components.

In the configuration depicted in the figure, the software components 1418, 1420 and 1422 of system 1400 are shown as being implemented on server 1412. In other embodiments, one or more of the components of system 1400 and/or the services provided by these components may also be implemented by one or more of the client computing devices 1402, 1404, 1406, and/or 1408. Users operating the client computing devices may then utilize one or more client applications to use the services provided by these components. These components may be implemented in hardware, firmware, software, or combinations thereof. It should be appreciated that various different system configurations are possible, which may be different from distributed system 1400. The embodiment shown in the figure is thus one example of a distributed system for implementing an embodiment system and is not intended to be limiting.

Client computing devices 1402, 1404, 1406, and/or 1408 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 1402, 1404, 1406, and 1408 may be any other electronic device, such as a thin-client computer, an Internet-enabled gaming system (e.g., a Microsoft Xbox gaming console with or without a Kinect® gesture input device), and/or a personal messaging device, capable of communicating over network(s) 1410.

Although exemplary distributed system 1400 is shown with four client computing devices, any number of client computing devices may be supported. Other devices, such as devices with sensors, etc., may interact with server 1412.

Network(s) 1410 in distributed system 1400 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 1410 can be a local area network (LAN), such as one based on Ethernet, Token-Ring and/or the like. Network(s) 1410 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 1412 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 1412 can include one or more virtual machines running virtual operating systems, or other computing architectures involving virtualization. One or more flexible pools of logical storage devices can be virtualized to maintain virtual storage devices for the server. Virtual networks can be controlled by server 1412 using software defined networking In various embodiments, server 1412 may be adapted to run one or more services or software applications described in the foregoing disclosure. For example, server 1412 may correspond to a server for performing processing described above according to an embodiment of the present disclosure.

Server 1412 may run an operating system including any of those discussed above, as well as any commercially available server operating system. Server 1412 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 1412 may include one or more applications to analyze and consolidate data feeds and/or event updates received from users of client computing devices 1402, 1404, 1406, and 1408. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1412 may also include one or more applications to display the data feeds and/or real-time events via one or more display devices of client computing devices 1402, 1404, 1406, and 1408.

Distributed system 1400 may also include one or more databases 1414 and 1416. Databases 1414 and 1416 may reside in a variety of locations. By way of example, one or more of databases 1414 and 1416 may reside on a non-transitory storage medium local to (and/or resident in) server 1412. Alternatively, databases 1414 and 1416 may be remote from server 1412 and in communication with server 1412 via a network-based or dedicated connection. In one set of embodiments, databases 1414 and 1416 may reside in a storage-area network (SAN). Similarly, any necessary files for performing the functions attributed to server 1412 may be stored locally on server 1412 and/or remotely, as appropriate. In one set of embodiments, databases 1414 and 1416 may include relational databases, such as databases provided by Oracle, that are adapted to store, update, and retrieve data in response to SQL-formatted commands.

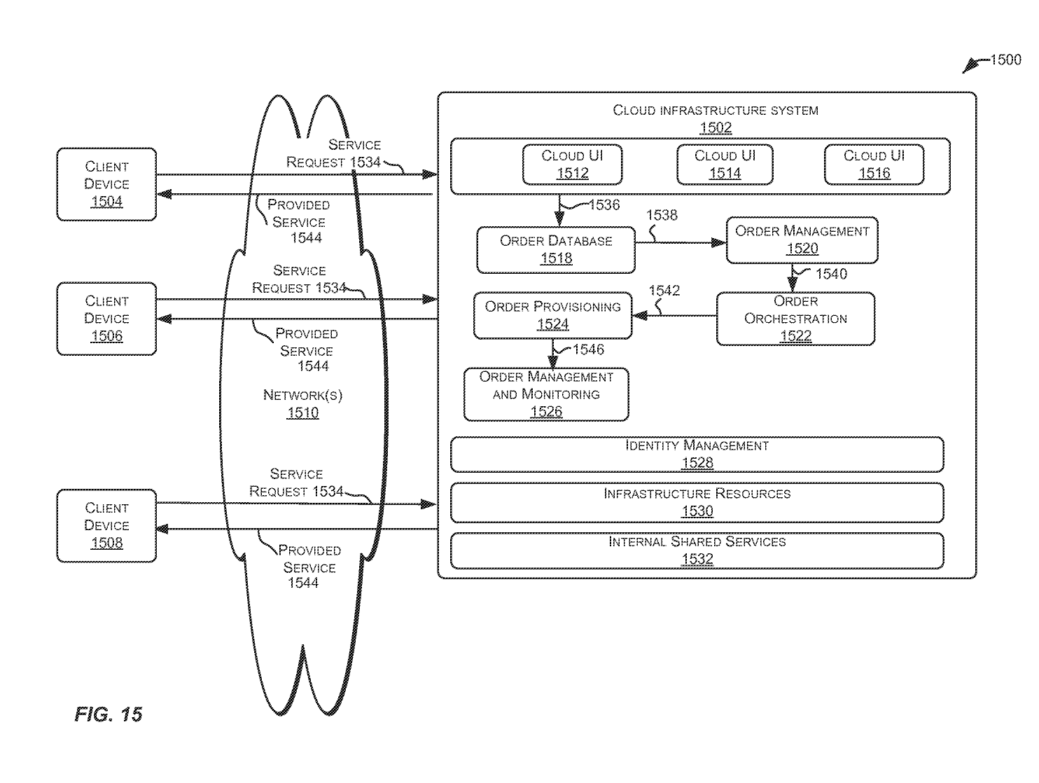

FIG. 15 is a simplified block diagram of one or more components of a system environment 1500 by which services provided by one or more components of an embodiment system may be offered as cloud services, in accordance with an embodiment of the present disclosure. In the illustrated embodiment, system environment 1500 includes one or more client computing devices 1504, 1506, and 1508 that may be used by users to interact with a cloud infrastructure system 1502 that provides cloud services. The client computing devices may be configured to operate a client application such as a web browser, a proprietary client application (e.g., Oracle Forms), or some other application, which may be used by a user of the client computing device to interact with cloud infrastructure system 1502 to use services provided by cloud infrastructure system 1502.

It should be appreciated that cloud infrastructure system 1502 depicted in the figure may have other components than those depicted. Further, the embodiment shown in the figure is only one example of a cloud infrastructure system that may incorporate an embodiment of the invention. In some other embodiments, cloud infrastructure system 1502 may have more or fewer components than shown in the figure, may combine two or more components, or may have a different configuration or arrangement of components.

Client computing devices 1504, 1506, and 1508 may be devices similar to those described above for 1402, 1404, 1406, and 1408.

Although exemplary system environment 1500 is shown with three client computing devices, any number of client computing devices may be supported. Other devices such as devices with sensors, etc. may interact with cloud infrastructure system 1502.

Network(s) 1510 may facilitate communications and exchange of data between clients 1504, 1506, and 1508 and cloud infrastructure system 1502. Each network may be any type of network familiar to those skilled in the art that can support data communications using any of a variety of commercially-available protocols, including those described above for network(s) 1410.

Cloud infrastructure system 1502 may comprise one or more computers and/or servers that may include those described above for server 1412.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1502 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

Large volumes of data, sometimes referred to as big data, can be hosted and/or manipulated by the infrastructure system on many levels and at different scales. Such data can include data sets that are so large and complex that it can be difficult to process using typical database management tools or traditional data processing applications. For example, terabytes of data may be difficult to store, retrieve, and process using personal computers or their rack-based counterparts. Such sizes of data can be difficult to work with using most current relational database management systems and desktop statistics and visualization packages. They can require massively parallel processing software running thousands of server computers, beyond the structure of commonly used software tools, to capture, curate, manage, and process the data within a tolerable elapsed time.

Extremely large data sets can be stored and manipulated by analysts and researchers to visualize large amounts of data, detect trends, and/or otherwise interact with the data. Tens, hundreds, or thousands of processors linked in parallel can act upon such data in order to present it or simulate external forces on the data or what it represents. These data sets can involve structured data, such as that organized in a database or otherwise according to a structured model, and/or unstructured data (e.g., emails, images, data blobs (binary large objects), web pages, complex event processing). By leveraging an ability of an embodiment to relatively quickly focus more (or fewer) computing resources upon an objective, the cloud infrastructure system may be better available to carry out tasks on large data sets based on demand from a business, government agency, research organization, private individual, group of like-minded individuals or organizations, or other entity.

In various embodiments, cloud infrastructure system 1502 may be adapted to automatically provision, manage and track a customer's subscription to services offered by cloud infrastructure system 1502. Cloud infrastructure system 1502 may provide the cloud services via different deployment models. For example, services may be provided under a public cloud model in which cloud infrastructure system 1502 is owned by an organization selling cloud services (e.g., owned by Oracle) and the services are made available to the general public or different industry enterprises. As another example, services may be provided under a private cloud model in which cloud infrastructure system 1502 is operated solely for a single organization and may provide services for one or more entities within the organization. The cloud services may also be provided under a community cloud model in which cloud infrastructure system 1502 and the services provided by cloud infrastructure system 1502 are shared by several organizations in a related community. The cloud services may also be provided under a hybrid cloud model, which is a combination of two or more different models.

In some embodiments, the services provided by cloud infrastructure system 1502 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1502. Cloud infrastructure system 1502 then performs processing to provide the services in the customer's subscription order.

In some embodiments, the services provided by cloud infrastructure system 1502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1502 may also include infrastructure resources 1530 for providing the resources used to provide various services to customers of the cloud infrastructure system. In one embodiment, infrastructure resources 1530 may include pre-integrated and optimized combinations of hardware, such as servers, storage, and networking resources to execute the services provided by the PaaS platform and the SaaS platform.

In some embodiments, resources in cloud infrastructure system 1502 may be shared by multiple users and dynamically re-allocated per demand. Additionally, resources may be allocated to users in different time zones. For example, cloud infrastructure system 1530 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1532 may be provided that are shared by different components or modules of cloud infrastructure system 1502 and by the services provided by cloud infrastructure system 1502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1502 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1502, and the like.

In one embodiment, as depicted in the figure, cloud management functionality may be provided by one or more modules, such as an order management module 1520, an order orchestration module 1522, an order provisioning module 1524, an order management and monitoring module 1526, and an identity management module 1528. These modules may include or be provided using one or more computers and/or servers, which may be general purpose computers, specialized server computers, server farms, server clusters, or any other appropriate arrangement and/or combination.

In exemplary operation 1534, a customer using a client device, such as client device 1504, 1506 or 1508, may interact with cloud infrastructure system 1502 by requesting one or more services provided by cloud infrastructure system 1502 and placing an order for a subscription for one or more services offered by cloud infrastructure system 1502. In certain embodiments, the customer may access a cloud User Interface (UI), cloud UI 1512, cloud UI 1514 and/or cloud UI 1516 and place a subscription order via these UIs. The order information received by cloud infrastructure system 1502 in response to the customer placing an order may include information identifying the customer and one or more services offered by the cloud infrastructure system 1502 that the customer intends to subscribe to.

After an order has been placed by the customer, the order information is received via the cloud UIs, 1512, 1514 and/or 1516.

At operation 1536, the order is stored in order database 1518. Order database 1518 can be one of several databases operated by cloud infrastructure system 1518 and operated in conjunction with other system elements.

At operation 1538, the order information is forwarded to an order management module 1520. In some instances, order management module 1520 may be configured to perform billing and accounting functions related to the order, such as verifying the order, and upon verification, booking the order.

At operation 1540, information regarding the order is communicated to an order orchestration module 1522. Order orchestration module 1522 may utilize the order information to orchestrate the provisioning of services and resources for the order placed by the customer. In some instances, order orchestration module 1522 may orchestrate the provisioning of resources to support the subscribed services using the services of order provisioning module 1524.

In certain embodiments, order orchestration module 1522 can enable the management of business processes associated with each order and applies business logic to determine whether an order should proceed to provisioning. At operation 1542, upon receiving an order for a new subscription, order orchestration module 1522 sends a request to order provisioning module 1524 to allocate resources and configure those resources needed to fulfill the subscription order. Order provisioning module 1524 enables the allocation of resources for the services ordered by the customer. Order provisioning module 1524 provides a level of abstraction between the cloud services provided by cloud infrastructure system 1500 and the physical implementation layer that is used to provision the resources for providing the requested services. Order orchestration module 1522 may thus be isolated from implementation details, such as whether or not services and resources are actually provisioned on the fly or pre-provisioned and only allocated/assigned upon request.

At operation 1544, once the services and resources are provisioned, a notification of the provided service may be sent to customers on client devices 1504, 1506 and/or 1508 by order provisioning module 1524 of cloud infrastructure system 1502.

At operation 1546, the customer's subscription order may be managed and tracked by an order management and monitoring module 1526. In some instances, order management and monitoring module 1526 may be configured to collect usage statistics for the services in the subscription order, such as the amount of storage used, the amount data transferred, the number of users, and the amount of system up time and system down time.

In certain embodiments, cloud infrastructure system 1500 may include an identity management module 1528. Identity management module 1528 may be configured to provide identity services, such as access management and authorization services in cloud infrastructure system 1500. In some embodiments, identity management module 1528 may control information about customers who wish to utilize the services provided by cloud infrastructure system 1502. Such information can include information that authenticates the identities of such customers and information that describes which actions those customers are authorized to perform relative to various system resources (e.g., files, directories, applications, communication ports, memory segments, etc.) Identity management module 1528 may also include the management of descriptive information about each customer and about how and by whom that descriptive information can be accessed and modified.

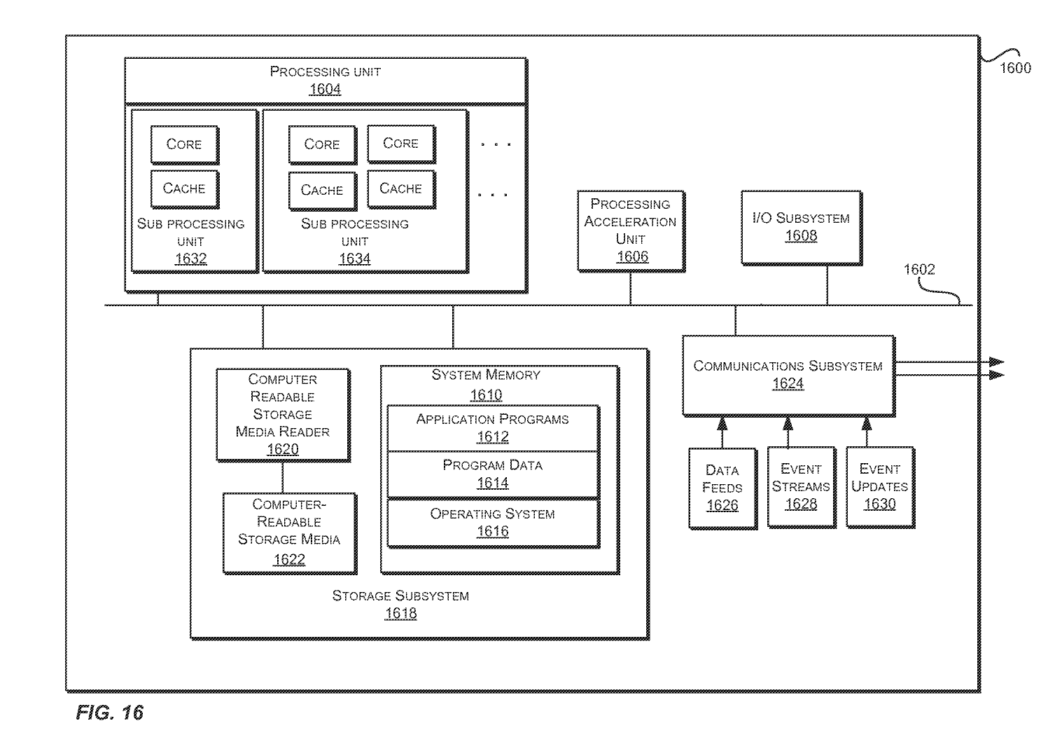

FIG. 16 illustrates an exemplary computer system 1600, in which various embodiments of the present invention may be implemented. The system 1600 may be used to implement any of the computer systems described above. As shown in the figure, computer system 1600 includes a processing unit 1604 that communicates with a number of peripheral subsystems via a bus subsystem 1602. These peripheral subsystems may include a processing acceleration unit 1606, an I/O subsystem 1608, a storage subsystem 1618 and a communications subsystem 1624. Storage subsystem 1618 includes tangible computer-readable storage media 1622 and a system memory 1610.

Bus subsystem 1602 provides a mechanism for letting the various components and subsystems of computer system 1600 communicate with each other as intended. Although bus subsystem 1602 is shown schematically as a single bus, alternative embodiments of the bus subsystem may utilize multiple buses. Bus subsystem 1602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1604, which can be implemented as one or more integrated circuits (e.g., a conventional microprocessor or microcontroller), controls the operation of computer system 1600. One or more processors may be included in processing unit 1604. These processors may include single core or multicore processors. In certain embodiments, processing unit 1604 may be implemented as one or more independent processing units 1632 and/or 1634 with single or multicore processors included in each processing unit. In other embodiments, processing unit 1604 may also be implemented as a quad-core processing unit formed by integrating two dual-core processors into a single chip.

In various embodiments, processing unit 1604 can execute a variety of programs in response to program code and can maintain multiple concurrently executing programs or processes. At any given time, some or all of the program code to be executed can be resident in processor(s) 1604 and/or in storage subsystem 1618. Through suitable programming, processor(s) 1604 can provide various functionalities described above. Computer system 1600 may additionally include a processing acceleration unit 1606, which can include a digital signal processor (DSP), a special-purpose processor, and/or the like.

I/O subsystem 1608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1600 may comprise a storage subsystem 1618 that comprises software elements, shown as being currently located within a system memory 1610. System memory 1610 may store program instructions that are loadable and executable on processing unit 1604, as well as data generated during the execution of these programs.

Depending on the configuration and type of computer system 1600, system memory 1610 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1604. In some implementations, system memory 1610 may include multiple different types of memory, such as static random access memory (SRAM) or dynamic random access memory (DRAM). In some implementations, a basic input/output system (BIOS), containing the basic routines that help to transfer information between elements within computer system 1600, such as during start-up, may typically be stored in the ROM. By way of example, and not limitation, system memory 1610 also illustrates application programs 1612, which may include client applications, Web browsers, mid-tier applications, relational database management systems (RDBMS), etc., program data 1614, and an operating system 1616. By way of example, operating system 1616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 1618 may also provide a tangible computer-readable storage medium for storing the basic programming and data constructs that provide the functionality of some embodiments. Software (programs, code modules, instructions) that when executed by a processor provide the functionality described above may be stored in storage subsystem 1618. These software modules or instructions may be executed by processing unit 1604. Storage subsystem 1618 may also provide a repository for storing data used in accordance with the present invention.

Storage subsystem 1600 may also include a computer-readable storage media reader 1620 that can further be connected to computer-readable storage media 1622. Together and, optionally, in combination with system memory 1610, computer-readable storage media 1622 may comprehensively represent remote, local, fixed, and/or removable storage devices plus storage media for temporarily and/or more permanently containing, storing, transmitting, and retrieving computer-readable information.

Computer-readable storage media 1622 containing code, or portions of code, can also include any appropriate media known or used in the art, including storage media and communication media, such as but not limited to, volatile and non-volatile, removable and non-removable media implemented in any method or technology for storage and/or transmission of information. This can include tangible, non-transitory computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. When specified, this can also include nontangible, transitory computer-readable media, such as data signals, data transmissions, or any other medium which can be used to transmit the desired information and which can be accessed by computing system 1600.

By way of example, computer-readable storage media 1622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1622 may include, but is not limited to, Zip® drives, flash memory cards, universal serial bus (USB) flash drives, secure digital (SD) cards, DVD disks, digital video tape, and the like. Computer-readable storage media 1622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1600.

Communications subsystem 1624 provides an interface to other computer systems and networks. Communications subsystem 1624 serves as an interface for receiving data from and transmitting data to other systems from computer system 1600. For example, communications subsystem 1624 may enable computer system 1600 to connect to one or more devices via the Internet. In some embodiments communications subsystem 1624 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1624 can provide wired network connectivity (e.g., Ethernet) in addition to or instead of a wireless interface.

In some embodiments, communications subsystem 1624 may also receive input communication in the form of structured and/or unstructured data feeds 1626, event streams 1628, event updates 1630, and the like on behalf of one or more users who may use computer system 1600.

By way of example, communications subsystem 1624 may be configured to receive data feeds 1626 in real-time from users of social media networks and/or other communication services such as Twitter® feeds, Facebook® updates, web feeds such as Rich Site Summary (RSS) feeds, and/or real-time updates from one or more third party information sources.

Additionally, communications subsystem 1624 may also be configured to receive data in the form of continuous data streams, which may include event streams 1628 of real-time events and/or event updates 1630, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1624 may also be configured to output the structured and/or unstructured data feeds 1626, event streams 1628, event updates 1630, and the like to one or more databases that may be in communication with one or more streaming data source computers coupled to computer system 1600.

Computer system 1600 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Embodiments described above may make reference to data structures and databases or data stores. It is to be understood that these terms can encompass any techniques for organizing information into discrete records that can be stored, retrieved and interpreted by computer systems.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A computer-implemented method comprising:
determining, by a processor, distribution information for distribution of a purchase order;
receiving a request to separate a portion of the distribution for the purchase order into a plurality of different distributions;
determining an original requisition identifier of a purchase requisition associated with the purchase order; and
storing the distribution information for each of the plurality of different distributions in association with the original requisition identifier.

2. The method of claim 1, wherein storing the distribution information for the plurality of different distributions includes:
generating a new distribution record for each of the plurality of different distributions; and
storing the new distribution record for each of the plurality of different distributions in association with the original requisition identifier.

3. The method of claim 1, further comprising:
separating the portion of the distribution based on different distributions for the good, wherein each of the plurality of different distributions correspond to a different delivery location.

4. The method of claim 1, further comprising:
separating the portion of the distribution based on different party charged for the good, wherein each of the plurality of different distributions correspond to a different party that is charged for a different distribution.

5. The method of claim 1, wherein the method further comprises:
separating the portion of the distribution based on different billing schedules for the good, wherein each of the plurality of different distributions correspond to a different billing schedule.

6. The method of claim 1, further comprising:
generating a graphical user interface that displays distribution information associated with the distribution of the purchase order for the purchase requisition;
wherein the request is received via interaction with the graphical user interface; and
wherein the request includes information for the plurality of different distributions.

7. The method of claim 1, further comprising:
retrieving a plurality of distributions for the distribution of the purchase order, wherein the plurality of distributions are retrieved based on the original requisition identifier; and
generating a graphical user interface that displays the plurality of distributions for the distribution of the purchase order, wherein each of the plurality of distributions are displayed with status information.

8. The method of claim 1, further comprising:
receiving information identifying a new purchase order associated with the purchase requisition;
receiving one or more new distributions associated with the new purchase order; and
storing the one or more new distributions in association with the original requisition identifier.

9. The method of claim 1, further comprising:
receiving input identifying criteria to search for one or more purchase requisitions;
determining a particular requisition identifier for a particular purchase requisition that satisfies the criteria; and
retrieving a plurality of distributions associated with the particular requisition identifier.

10. A computing system, comprising:
a processor; and
a memory coupled with and readable by the processor and storing therein a set of instructions which, when executed by the processor, cause the processor to perform a method comprising:
determining a schedule for a purchase order;
receiving a request to separate the schedule for the purchase order into plurality of different schedules;
determining an original requisition identifier of a purchase requisition associated with the purchase order;
generating a new schedule record for each of the plurality of different schedules; and
storing the new schedule record for each of the plurality of different schedules in association with the original requisition identifier.

11. The computing system of claim 10, wherein the method further comprises:
modifying an existing schedule record for the separated schedule.

12. The computing system of claim 10, wherein the method further comprises:
separating the schedule based on different shipping schedules for the purchase order, wherein each of the plurality of different schedules correspond to a different shipping schedule.

13. The computing system of claim 10, wherein the method further comprises:
separating the schedule based on different delivery schedules for the purchase order, wherein each of the plurality of different schedules correspond to a different delivery schedule.

14. The computing system of claim 10, wherein the method further comprises:
generating a graphical user interface that displays schedule information associated with the schedule of the purchase order for the purchase requisition;
wherein the request is received via interaction with the graphical user interface; and
wherein the request includes information for the plurality of different schedules, wherein the information indicates one or both of a shipping schedule or a delivery schedule for the separated schedule.

15. The computing system of claim 10, wherein the method further comprises:
retrieving a plurality of schedules for the separated schedule of the purchase order, wherein the plurality of schedules are retrieved based on the original requisition identifier; and
generating a graphical user interface that displays the plurality of schedules for the schedule of the purchase order, wherein each of the plurality of schedules are displayed with status information.

16. The computing system of claim 10, wherein the method further comprises:
receiving information identifying a new purchase order associated with the purchase requisition;
receiving one or more new schedules associated with the new purchase order; and
storing each of the one or more new schedules in association with the original requisition identifier.

17. The computing system of claim 10, wherein the method further comprises:
receiving input identifying criteria to search for one or more purchase requisitions;
determining a particular requisition identifier for a particular purchase requisition that satisfies the criteria; and
retrieving a plurality of schedules associated with the particular requisition identifier.

18. The computing system of claim 10, wherein the method further comprises:
determining a distribution associated with the schedule for the purchase order; and
generating a new distribution record for distribution associated with each of the plurality of different schedules in association with the original requisition identifier; and
storing the new distribution record for each of the plurality of different schedules in association with the original requisition ID.

19. A computer-readable memory comprising a set of instructions stored thereon which, when executed by a processor, cause the processor to perform a method comprising:
determining, by a processor, distribution information for distribution of a purchase order;
receiving a request to separate a portion of the distribution for the purchase order into a plurality of different distributions;
determining an original requisition identifier of a purchase requisition associated with the purchase order; and
storing the distribution information for each of the plurality of different distributions in association with the original requisition identifier.

20. The computer-readable memory of claim 19, wherein storing the distribution information for the plurality of different distributions includes:
generating a new distribution record for each of the plurality of different distributions; and
storing the new distribution record for each of the plurality of different distributions in association with the original requisition identifier.
